(19) United States
(12) Patent Application Publication
(10) Pub. No.: US 2026/0119789 A1
(43) Pub. Date: Apr. 30, 2026

(54) SYSTEMS AND METHODS FOR GENERATING SLIDES USING MACHINE LEARNING

(71) Applicant: MCKINSEY & COMPANY, INC., New York, NY (US)

(72) Inventors: Jeffrey Lewis, Westfield, NJ (US); Phil Hudelson, St. Albans (GB); Peter Mondlock, Highland Park, IL (US); Kitti Lakner, Wayne, NY (US); Erik Alexander Roth, Westport, CT (US); Sahil Puri, West New York, NJ (US); Omer Keinan, Wayland, MA (US); Rodrigo Olivares Lopez, New York, NY (US); Shaleenraj Kaur, New York, NY (US)

(21) Appl. No.: 18/929,908

(22) Filed: Oct. 29, 2024

(51) Int. Cl. G06F 40/186; G06F 40/109; G06F 40/40

(52) U.S. Cl. CPC G06F 40/186; G06F 40/109; G06F 40/40

(57) ABSTRACT

Systems and methods for generating a slide using machine learning (ML) are provided. The system may obtain content of a new slide, cause a large language model (LLM) to generate a slide layout for the new slide content, and determine a subset of template slides. The LLM may cause a template recommendation model to select a template slide best suited to display the content from the subset of template slides. The LLM may cause a layout-mapping model to generate template slide element mapping describing elements of the template slide. The LLM may cause a slide generator model to generate the new slide by generating a mapping of the content to the one or more elements of the template slide, and populating the one or more elements with the content based upon the mapping. The system may display the new slide at a user interface of a computing device.

### FIELD OF THE DISCLOSURE

The present disclosure generally relates to systems and methods for generating content, and more particularly, to systems and methods to generate slides using machine learning.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Current slide generation tools employing artificial intelligence, such as large language models (LLMs), predominantly utilize custom-built slide templates having elements (e.g., a text box) annotated with detailed descriptions. The element descriptions enable LLMs to populate the elements of a slide coherently and contextually. For example, placeholders tagged with metadata can provide instruction to the LLM assisting with generating the slide to ensure element such as a title text box, a subtitle text box, or key message text box is filled with appropriate content. Unfortunately, the required use of annotated generic template slides prevents convention artificial intelligence slide generation tools from using customized templates created by a user and/or organization that may be of a higher quality, provide a greater variety of template options, include desired design aspects, and/or have other characteristics than those of template slides conventional artificial intelligence slide generation tools use to generate slides.

Therefore, there is an opportunity and need for improved systems and methods for using artificial intelligence to generate slides based upon existing slide templates.

### BRIEF SUMMARY

In one embodiment, the disclosure provides a system for generating a slide using machine learning. The system may include one or more processors, and one or more non-transitory memories storing processor-executable instructions that, when executed by the one or more processors, cause the system to: (i) obtain content data indicating content of a new slide; (ii) generate a first prompt for a large language model (LLM) to generate a description of a layout of the new slide based upon the content of the new slide; (iii) responsive to the LLM receiving the first prompt, generate new slide layout data including the description of the layout of the new slide; (iv) obtain template slide layout data including a description of the layout of each template slide of a plurality of template slides; (v) based upon the new slide layout data and the template slide layout data, determine a subset of template slides of the plurality of template slides having respective layouts similar to the layout of the new slide; (vi) generate a second prompt for the LLM to select a template slide of the subset of template slides best suited for the content, wherein the template slide is used as a template for the new slide; (vii) responsive to the LLM receiving the second prompt, cause a template recommendation model to select the template slide based upon the content data and respective layouts of the subset of template slides; (viii) obtain template slide metadata indicating layout characteristics of one or more elements of the template slide, and template slide image data comprising an image of the template slide; (ix) generate a third prompt for the LLM to generate a mapping of the one or more elements of the template slide including a description of the one or more elements of the template slide; (x) responsive to the LLM receiving the third prompt, cause a layout-mapping model to generate template slide element mapping data including the description of the one or more elements of the template slide based upon the template slide metadata and the template slide image data; (xi) generate a fourth prompt for the LLM to generate the new slide based on the content and the description of the one or more elements of the template slide; (xii) responsive to the LLM receiving the fourth prompt, generate the new slide by applying a slide generator model to the template slide element mapping data and the content data, wherein to generate the new slide includes: generating a mapping of the content to the one or more elements of the template slide, and populating the one or more elements with the content based upon the mapping; and (xiii) display, at a user interface of a computing device, the new slide. The system may include additional, less, or alternate functionality, including that discussed elsewhere herein.

In a variation of the embodiment, the one or more elements may include a text box; and one or more of: the layout characteristics of the one or more elements may include one or more of: a quantity of text boxes, a size of the text box, a font of the text box, or a location of the text box, or the description of the one or more elements may include one or more of: an identifier of the text box, a type of content of the text box, a shape of the text box, or a text capacity of the text box.

In another variation of the embodiment, the new slide may be a first new slide of a plurality of new slides; and the system may further comprise instructions that, when executed by the one or more processors, cause the system to generate the plurality of new slides.

In yet another variation of the embodiment, the system may further comprise instructions that, when executed by the one or more processors, cause the system to: display, at the user interface, an indication of the subset of template slides; and receive, via the user interface, a selection of the template slide.

In still yet another variation of the embodiment, the system may further comprise instructions that, when executed by the one or more processors, cause the system to: determine one or more categories of the plurality of template slides, wherein to determine the subset of template slides may be further based upon the one or more categories of the template slide.

In a variation of the embodiment, the system may further comprise instructions that, when executed by the one or more processors, cause the system to: generate the template slide layout data for the plurality of template slides by applying the layout-mapping model to all template slide metadata indicating layout characteristics of the plurality of template slides, and all template slides image data comprising an image of each of the plurality of template slides.

In another variation of the embodiment, the template recommendation model may be trained using template recommendation model training data that may include historical slides including historical content and historical layouts of historical template slides; and the template recommendation model may be trained to make associations between the historical template slides having the historical layouts best suited for displaying the historical content.

In yet another variation of the embodiment, the template recommendation model may determine the subset of template slides based upon the new slide layout data and the template slide layout data.

In still yet another variation of the embodiment, the layout-mapping model may be trained using layout-mapping model that may include historical template slides including historical elements, historical template slide metadata of the historical template slides, historical template slide images of the historical slides, historical template slide mappings of the historical slides, and historical temple slide layouts of the historical slides; and the layout-mapping model may be trained to make associations between historical images of the historical elements, the historical template slide layouts, historical layout characteristics of the historical elements, and historical descriptions of the historical elements.

In a variation of the embodiment, the layout-mapping model may include a GPT4Vision model.

In another variation of the embodiment, the slide generator model may be trained using slide generator model training data that may include historical content of historical slides, historical template slides including historical elements, historical slide template mappings and historical slides having the historical content populated into the historical elements; and the slide generator model may be trained to make associations between the historical elements, the historical content, and the historical content populated in the historical elements.

In another embodiment, the disclosure provides a computer-implemented method for generating a slide using machine learning. The computer-implemented may include (i) obtaining, by one or more processors, content data indicating content of a new slide; (ii) generating, by the one or more processors, a first prompt for a large language model (LLM) to generate a description of a layout of the new slide based upon the content of the new slide; (iii) responsive to the LLM receiving the first prompt, generating, by the one or more processors, new slide layout data including the description of the layout of the new slide; (iv) obtaining, by the one or more processors, template slide layout data including a description of the layout of each template slide of a plurality of template slides; (v) based upon the new slide layout data and the template slide layout data, determining, by the one or more processors, a subset of template slides of the plurality of template slides having respective layouts similar to the layout of the new slide; (vi) generating, by the one or more processors, a second prompt for the LLM to select a template slide of the subset of template slides best suited for the content, wherein the template slide is used as a template for the new slide; (vii) responsive to the LLM receiving the second prompt, causing, by the one or more processors, a template recommendation model to select the template slide based upon the content data and respective layouts of the subset of template slides; (viii) obtaining, by the one or more processors, template slide metadata indicating layout characteristics of one or more elements of the template slide, and template slide image data comprising an image of the template slide; (ix) generating, by the one or more processors, a third prompt for the LLM to generate a mapping of the one or more elements of the template slide including a description of the one or more elements of the template slide; (x) responsive to the LLM receiving the third prompt, causing, by the one or more processors, a layout-mapping to generate template slide element mapping data including the description of the one or more elements of the template slide based upon the template slide metadata and the template slide image data; (xi) generating, by the one or more processors, a fourth prompt for the LLM to generate the new slide based on the content and the description of the one or more elements of the template slide; (xii) responsive to the LLM receiving the fourth prompt, generating, by the one or more processors, the new slide by applying a slide generator model to the template slide element mapping data and the content data, wherein to generating the new slide includes: generating a mapping of the content to the one or more elements of the template slide, and populating the one or more elements with the content based upon the mapping; and (xiii) displaying, by the one or more processors at a user interface of a computing device, the new slide. The method may include additional, less, or alternate functionality or actions, including those discussed elsewhere herein.

In yet another embodiment, a non-transitory computer readable medium having processor-executable instructions stored thereon that, when executed by one or more processors, cause the one or more processors to at least: (i) obtain content data indicating content of a new slide; (ii) generate a first prompt for a large language model (LLM) to generate a description of a layout of the new slide based upon the content of the new slide; (iii) responsive to the LLM receiving the first prompt, generate new slide layout data including the description of the layout of the new slide; (iv) obtain template slide layout data including a description of the layout of each template slide of a plurality of template slides; (v) based upon the new slide layout data and the template slide layout data, determine a subset of template slides of the plurality of template slides having respective layouts similar to the layout of the new slide; (vi) generate a second prompt for the LLM to select a template slide of the subset of template slides best suited for the content, wherein the template slide is used as a template for the new slide; (vii) responsive to the LLM receiving the second prompt, cause a template recommendation model to select the template slide based upon the content data and respective layouts of the subset of template slides; (viii) obtain template slide metadata indicating layout characteristics of one or more elements of the template slide, and template slide image data comprising an image of the template slide; (ix) generate a third prompt for the LLM to generate a mapping of the one or more elements of the template slide including a description of the one or more elements of the template slide; (x) responsive to the LLM receiving the third prompt, cause a layout-mapping model to generate template slide element mapping data including the description of the one or more elements of the template slide based upon the template slide metadata and the template slide image data; (xi) generate a fourth prompt for the LLM to generate the new slide based on the content and the description of the one or more elements of the template slide; (xii) responsive to the LLM receiving the fourth prompt, generate the new slide by applying a slide generator model to the template slide element mapping data and the content data, wherein to generate the new slide includes: generating a mapping of the content to the one or more elements of the template slide, and populating the one or more elements with the content based upon the mapping; and (xiii) display, at a user interface of a computing device, the new slide. The instructions may direct additional, less, or alternate functionality, including that discussed elsewhere herein.

Additional, alternate and/or fewer actions, steps, features and/or functionality may be included in an aspect and/or embodiments, including those described elsewhere herein.

### BRIEF DESCRIPTION OF THE DRAWINGS

The figures described below depict various aspects of the system and methods disclosed therein. It should be understood that each figure depicts one embodiment of a particular aspect of the disclosed system and methods, and that each of the figures is intended to accord with a possible embodiment thereof. Further, wherever possible, the following description refers to the reference numerals included in the following figures, in which features depicted in multiple figures are designated with consistent reference numerals.

There are shown in the drawings arrangements which are presently discussed, it being understood, however, that the present aspects are not limited to the precise arrangements and instrumentalities shown, wherein:

FIG. 1 depicts a block diagram of an exemplary computing environment in which methods and systems for generating a slide using machine learning may be implemented, according to some embodiments.

FIG. 2A depicts a combined block and logic diagram for training an exemplary machine learning model, according to some embodiments.

FIG. 2B depicts a combined block and logic diagram for training an exemplary LLM, according to some embodiments.

FIG. 3A depicts an exemplary slide generated using machine learning, according to some embodiments.

FIG. 3B depicts an exemplary template slide having an ideal layout for new slide content, according to some embodiments.

FIG. 3C depicts an exemplary slide of a conventional slide generation tool, according to some embodiments.

FIG. 3D depicts an exemplary template slide having elements identifiers and bounding boxes, according to some embodiments.

FIG. 3E depicts an exemplary element mapping for a template slide, according to some embodiments.

FIG. 3F depicts an exemplary template slide layout for a template slide, according to some embodiments.

FIG. 4 depicts a flow diagram of an exemplary computer-implemented method for generating a slide using machine learning, according to some embodiments.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### DETAILED DESCRIPTION

### Overview

Broadly speaking, the techniques of the present disclosure relate to generating a slide using machine learning (ML). The disclosed systems and methods may include using a large language model (LLM), and an ensemble of machine learning models at the direction of the LLM, to generate a new slide from any number of existing template slides. The disclosed techniques may obtain content for a new slide, and determine an existing template slide best suited to display the content. Determining the best-suited template slide may include generating a first LLM prompt that, once received by the LLM, causes the LLM to generate a description of an ideal slide layout best suited to display the new slide content. Generating a second prompt that the LLM receives may cause a template recommendation model to select the template slide best suited for the new slide content based upon the ideal slide layout and descriptions of multiple template slide layouts. Generating a third prompt that the LLM receives may cause a layout-mapping model to generate a description of all of the elements of the template slide (e.g., identifiers, content types, shapes, text capacities) based upon an image of the selected template slide and its metadata indicating layout characteristics (e.g., element quantities, sizes, fonts, locations). Generating a fourth prompt that the LLM receives may cause a slide generator model to generate the new slide by mapping and populating the new slide content into the template slide elements best suited to display the content. The user interface of a computing device may display the new slide.

In accordance with the above, and with the disclosure herein, the present disclosure includes improvements in slide generation technologies at least because the techniques employ an ensemble of models working in conjunction to generate a new slide from a library of existing template slides, rather than having a tool generate a slide using a template slide that may not be appropriately designed or suitable organized to effectively display desired content. The template recommendation model leverages specifically trained capabilities to find the optimal template slide layout from any number (e.g., hundreds or thousands) of exiting template slide options to best present the provided content. Using template slide metadata and a visual representation of the template slide, a layout-mapping model delineates the purpose and context of each element of the template, which the slide generator model subsequently utilizes to intelligently and coherently populate the template slide, placing the correct type of content in its designated area. Each of the ensemble of models provides an output that is built upon through a series of steps to provide an understanding the characteristics and features unique to any existing slide template rather than relying on less effective templates of a slide generation tool, and uses the understanding of the unique aspects of a template to effectively display content in a manner that conventions tools are not able to duplicate. The disclosure techniques improve the efficiency and effectiveness of slide generation by providing advanced functionalities that allow any number of slides having any level of complexity in a pre-existing slide library to be used as a template for generating a new slide.

As just described, the present disclosure includes specific features other than that which is well-understood, routine, conventional activity in the field, and/or otherwise adds unconventional steps that confine the disclosure to a particular useful application. Such steps may include, but are not limited to causing a template recommendation model to select a template slide based upon new slide content and respective layouts of template slides, causing a layout-mapping model to generate a mapping describing the elements of the template slide based upon template slide metadata and image data, and causing the slide generator model to generate the new slide based upon the template slide element mapping and the new slide content. Indeed, the unconventional steps of using multiple machine learning models in tandem to generate a new slide based upon an analysis and understand of aspects and characteristics of an existing template slide already known to be of suitable use to an organization, among other things, confined the disclosed techniques to a particular useful application for generating a new slide.

### Exemplary Computing Environment

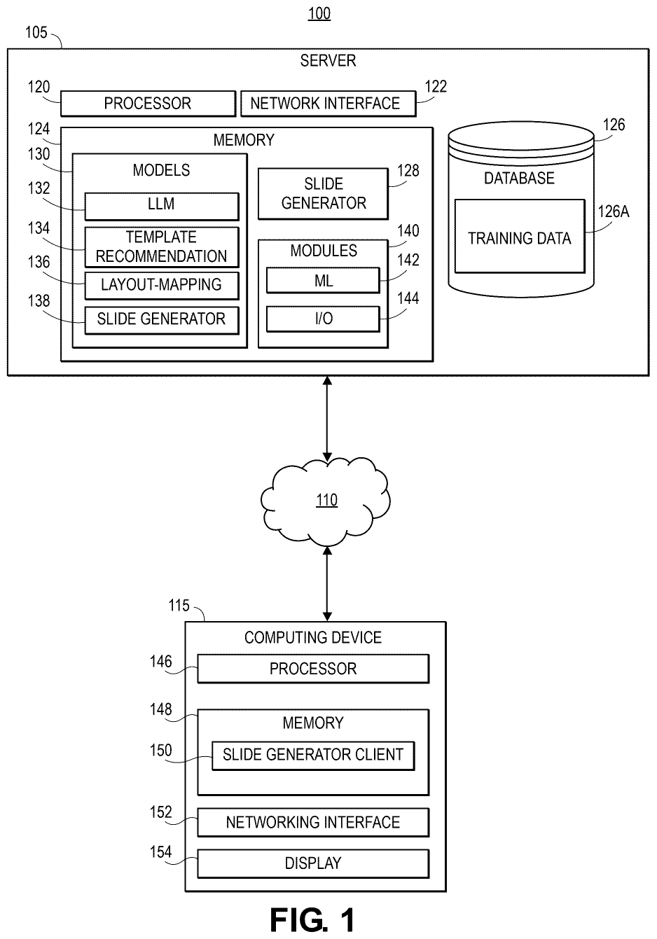

FIG. 1 depicts an exemplary computing environment 100 in which methods and systems for generating a slide using machine learning (ML) may be implemented, according to some embodiments. The computing environment 100 may include at least one server 105 and at least one computing device 115 communicatively coupled via a network 110. Although FIG. 1 depicts certain entities, components, equipment, and/or devices, it should be appreciated that additional, fewer, and/or alternate entities, components, equipment, and/or devices are envisioned.

The at least one server 105 may perform the at least some of the disclosed functionalities and techniques associated with generating a slide using machine learning. The server 105, referred to at times more generically as a “computing device” or “device,” may be part of a cloud network or may otherwise communicate with other hardware or software components within one or more cloud computing environments to send, retrieve, or otherwise analyze data or information described herein. In some embodiments, the computing environment 100 may comprise an on-premises computing environment, a multi-cloud computing environment, a public cloud computing environment, a private cloud computing environment, and/or a hybrid cloud computing environment. In one example, an entity may host one or more services (e.g., slide generation) in a public cloud computing environment (e.g., Amazon Web Services (AWS), Google Cloud, IBM Cloud, Microsoft Azure, etc.). The public cloud computing environment may be a traditional off-premises cloud (i.e., not physically hosted at a location owned/controlled by the business). Alternatively, or in addition, aspects of the public cloud may be hosted on-premises at a location owned/controlled by the entity. The public cloud may be partitioned using visualization and multi-tenancy techniques and/or may include one or more of software-as-a-service (SaaS), infrastructure-as-a-service (IaaS) and/or platform-as-a-service (PaaS). In one aspect, the server 105 may include a client-server platform technology such as ASP.NET, Java J2EE, Ruby on Rails, Node.js, a web service or online API, responsive for receiving and responding to electronic requests.

The server 105 may include a network interface 122. The network interface 122 may allow the server 105 to communicate over the network 110 via any suitable wired and/or wireless connection, e.g., using any suitable network interface controller(s) of the network interface 122. The network interface 122 may include one or more transceivers (e.g., WWAN, WLAN, and/or WPAN transceivers) functioning in accordance with IEEE reference standards, 3GPP reference standards, and/or other reference standards that may be used in receipt and transmission of data via external/network ports of the server 105 connected to computer network 110.

The server 105 may include at least one processor 120. The processor 120 may include one or more suitable processors (e.g., central processing units (CPUs) and/or graphics processing units (GPUs)). The processor 120 may be communicatively coupled to a memory 124 via a computer bus (not depicted) that transmits electronic data, data packets, or otherwise electronic signals to and from the processor 120 and the memory 124 in order to execute, implement or perform the machine-readable instructions, methods, processes, elements, or limitations, as illustrated, depicted, or described for the various flowcharts, illustrations, diagrams, figures, and/or other disclosure herein. The processor 120 may interface with the memory 124 to execute an operating system, computing instructions contained therein, and/or to access other services/aspects. For example, the processor 120 may interface with the memory 124 via the computer bus to create, read, update, delete, or otherwise access or interact with the data stored in the memory 124, database 126, and/or another source of data.

The memory 124 may include one or more forms of volatile, nonvolatile, non-transitory, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others. The memory 124 may store the operating system (e.g., Microsoft Windows, Linux, UNIX, etc.) capable of facilitating the functionalities, apps, methods, or other software as described herein. The memory 124 may store one or more sets of non-transitory, computer-executable instructions that, when executed, cause the server 105 to perform certain functions.

In general, a computer program or computer-based product, application, or code (e.g., ML models, or other computing instructions described herein) may be stored on a computer usable storage medium, or tangible, non-transitory computer-readable medium (e.g., reference random access memory (RAM), an optical disc, a universal serial bus (USB) drive, a hard drive or the like) having such computer-readable program code or computer instructions embodied therein. The computer-readable program code or computer instructions may be installed on, or otherwise adapted to be, executed by the processor 120 (e.g., working in connection with the respective operating system in the memory 124) to facilitate, implement, or perform the machine readable instructions, methods, processes, elements or limitations, as illustrated, depicted, or described for the various flowcharts, illustrations, diagrams, figures, and/or other disclosure herein. In this regard, the program code may be implemented in any desired program language, and may be implemented as machine code, assembly code, byte code, interpretable source code or the like (e.g., via Golang, Python, C, C++, C #, Objective C, Java, Scala, ActionScript, JavaScript, HTML, CSS, XML, etc.).

The server 105 may include, and/or be communicatively coupled to (e.g., via the network 110), at least one electronic database 126. The database 126 may include a relational database, such as Oracle, DB2, MySQL, a NoSQL database such as MongoDB, and/or another other suitable database. The database 126 may store data, such as ML model training data 126A, ML models, ML model input and/or output data, template slides, template slide layout data, template slide element mapping data, template slide images, etc.

The memory 124 may store a Slide Generator application 128 that, when executed by the processor 120, performs one or more functions associated with generating slides using ML, such as obtaining content for a new slide, selecting a template for the new slide, mapping the content to elements of the template slide, operating and/or training ML models 130, etc. In some embodiments, a user of the server 105 (e.g., via a user interface of the server 105) executes the Slide Generator application 128, while in other embodiments the Slide Generator application 128 may be configured to execute automatically (e.g., according to a schedule, continuously, in response to a trigger event such as receiving slide content, etc.), and in yet other embodiments a remote user may execute and/or otherwise access the Slide Generator application 128 (e.g., via a Slide Generator client application 150 communicatively coupled to the server 105 via the network 110).

The memory 124 or other suitable storage (e.g., the database 126) of the computing environment 100 may store one or more ML models 130, routines, algorithms, or other elements (collectively “models” or “ML models”). The ML models 130 may be, or include, computer-executable instructions that when executed (e.g., by the processor 120 of the server 105, by the computing device 115) cause the one or more ML models to receive one or more inputs, and produce or store (e.g., in the memory 124, the database 126) one or more outputs. Further, the processor 120 should be understood to retrieve/access from the memory 124 and/or the database 126 any data necessary to perform the executed instructions (e.g., data required as an input to the ML model 130), and to store in the memory 124 and/or the database 126 the intermediate results and/or output of any executed instructions. It should be understood that although FIG. 1 depicts the ML models 130 as part of the memory 124, one or more of the ML models 130 may be considered as a computing module 140, may be stored in the database 126, may be stored on a device accessible via the network 110, etc.

The ML models 130 may include an LLM 132. Generally speaking, the LLM 132 may be trained to receive input data, and generate as an output new content that is reflective of the input. The LLM 132 may operate upon text and only generate text (e.g., code to create a resource) or, in other embodiments, may be a multimodal LLM that operates upon and/or generates text and also generates other types of content (e.g., images, audio, etc.) and/or performs other actions. The LLM 132 may receive a text prompt (referred to at times as simply a “prompt”) as an input, process the text prompt, and output text content responsive to the text prompt. The LLM 132 may include a deep neural network and may perform various natural language processing tasks as needed to understand a text query/prompt and generate a response to the text query/prompt. The LLM 132 may have a transformer model architecture with an encoder and decoder, and may characteristics tokenize inputs/text. The transformer model may incorporate self-attention mechanisms to facilitate faster learning/training and/or more accurate output. In some embodiments, the LLM 132 includes many layers of neural networks, possibly including a number of embedding layers, a number of feedforward layers, and a number of recurrent layers. The LLM 132 may be a general-purpose model (e.g., trained on a wide array of publicly available datasets such as web pages, documents, etc., available via the Internet) such as OpenAI's ChatGPT4. The LLM 132 may be a domain-specific model (e.g., trained and/or fine-tuned on custom and/or proprietary datasets), such a general purpose LLM trained using datasets indicative of terminology used when generating a slide, so the LLM 132 may perform one or more actions associated generating a slide (e.g., generating slide layout data). It should be understood that, while a large language model is generally referenced herein, the disclosed techniques may include one or more alternate and/or additional language models, such as a small language model (SML), a hybrid language model, and/or other suitable language model or model.

The ML models 130 may include a template recommendation model 134. In at least some embodiments, the selection model 134 may be, or include, a bidirectional encoder representations from transformer (BERT), a SentenceTransformer, a neural network, a skip-through vector, a decision tree, a graph, a weighted similarity score, and/or any other suitable model. The template recommendation model 134 may perform natural language processing (NLP)/natural language understanding (NLU), semantic matching and/or ranking, generate and/or rank embeddings (e.g., using similarity metric(s)). The selection model 134 may receive content data for a new slide, and multiple template slide layout descriptions (e.g., a structured JSON layout description containing different fields such as category, subcategory, number of sections, number of subsections, etc.) as an input, and select and/or recommend a template slide best suited for the new slide content as the output. The ML module 142 may train the selection model 134 using template recommendation model training data. The template recommendation model training data may include historical slides including historical content, historical layouts of historical template slides, and/or any other suitable template recommendation model training data. The template recommendation model 134 may be trained using template recommendation model training data to make associations between the historical template slides having the historical layouts best suited for displaying the historical content, and/or any other suitable associations.

In some embodiments, the LLM 132 may be prompted to describe the layouts of all template slides in a template slide library. A template slide layout description may be structured (e.g., feature extraction using LLMs) and/or otherwise contain features/information such as the type of slide, the number of sections, etc. The LLM 132 may be prompted to generate a description of the ideal slide layout for the content of the new slide. A template slide may have a layout matching the ideal new slide layout, or no template slide layout may match the ideal new slide layout in which case the ideal new slide layout may act as a reference for determining the template slide layout description most similar to the ideal new slide layout description. The ideal new slide layout description may be embedded (e.g., using the SentenceTransformer to convert the ideal new template layout description into a vector, numerical representation, etc.) and a ranking or otherwise scoring may be performed against the embeddings of the layout descriptions of all templates slides, such as using a similarity metric (e.g., cosine similarity) to determine the template slide best suited for the new slide content. In some embodiments, matching the ideal new slide layout description with a template slide layout description may include a graph, decision-tree, or similar approach.

The ML models 130 may include a layout-mapping model 136. The layout-mapping model 136 may be, or include, a generative model (e.g., GPT4 Vision, GPT4o) and/or any other suitable model. The layout-mapping model 136 may receive as inputs template slide metadata indicating layout characteristics of one or more elements of the template slide and the template slide image data of an image of the template slide (e.g., a template slide image with metadata overlaid on elements and/or bounding boxes around elements to indicate hierarchical and logical relationships). The layout characteristics of the elements may include a quantity of elements, a size of the element, a font of the element, a location of the element, and/or other suitable characteristic. The layout-mapping model 136 may generate as an output template slide layout data including a description of the layout of the template slide, and/or template slide element mapping data (e.g., also referred to as a “schema”) including a description the elements of each of the template slide. The layout-mapping model 136 may generate the template slide layout data and/or the template slide element mapping data in batches (e.g., for a library of slide). The layout-mapping model 136 may store the template slide layout data and/or the template slide element mapping data in memory (stored in memory (e.g., the memory 124, the database 126). The description of a template slide element (e.g. a text box) may include an element identifier, a type of content of the element (e.g., a title, a description, etc.), the shape of the element (e.g., a square, a rectangle, small, large), a text capacity of the element (e.g., 35 words), and/or any other suitable description of the element. In at least some embodiments, the description of the layout may include a categorization of the layout (e.g., a layout for a process). The layout-mapping model 136 may be trained using layout-mapping model training data. The layout-mapping model training data may include historical template slides including historical elements, historical template slide metadata of the historical template slides, historical template slide images of the historical slides, historical template slide mappings of the historical slides, historical temple slide layouts of the historical slides, and/or any other suitable layout-mapping model training data. The layout-mapping model maybe trained to make associations between historical images of the historical elements, the historical template slide layouts, historical layout characteristics of the historical elements, historical descriptions of the historical elements, and/or any other suitable associations. In some embodiments, the layout-mapping model 136 may be an available pretrained model that does not require training.

The ML models 130 may include a slide generator model 138. The slide generator model 138 may be, or include, a generative model (e.g., GPT4 Vision, GPT4o) and/or other suitable model. The slide generator model 138 may receive the template slide element mapping data of the template slide and the content data of the new slide and generate the new slide as the output. The slide generator model 138 may be trained using slide generator model training data. The slide generator model training data may include historical content of historical slides, historical template slides including historical elements, historical slide template mappings, historical slides having the historical content populated into the historical elements, and/or other suitable slide generator model training data. The slide generator model 138 may be trained to make associations between the historical elements, the historical content, the historical content populated in the historical elements, and/or other suitable associations. In some embodiments, the slide generator model 138 may be an available pretrained model that does not require training.

The database 126 or other suitable memory (e.g., the memory 124) may store one or more sets of training data 126A, such as LLM training data, template recommendation model training data, layout-mapping model training data, and/or slide generator training data. The training data 126A may include testing data, validation data, feedback data, and/or other training data which may be used to create, operate, (re)train and/or fine-tune the ML models 130.

The memory 124 may store one or more computing modules 140, implemented as respective sets of computer-executable instructions (e.g., one or more source code libraries), as described herein.

The computing modules 140 may include the ML module 142. In some embodiments, ML models (e.g., the ML models 130) may be applied by the ML module 142, which may include, but are not limited to linear or logistic regression algorithms, instance-based algorithms, regularization algorithms, decision trees, Bayesian networks, cluster analysis, association rule learning, artificial neural networks, deep learning, combined learning, reinforced learning, dimensionality reduction, and support vector machines. In various embodiments, the implemented ML methods and algorithms are directed toward at least one of a plurality of categorizations of ML, such as supervised learning, unsupervised learning, and reinforcement learning. In one aspect, the ML based algorithms may be included as a library or package executed on server(s) 105. For example, libraries may include the TensorFlow based library, the Pytorch library, and/or the scikit learn Python library.

In one embodiment, the ML module 142 employs supervised learning, which involves identifying patterns in existing data to make predictions about subsequently received data.

Specifically, the ML module 142 is “trained” using training data (e.g., the training data 126A), which includes exemplary inputs and associated exemplary outputs. Based upon the training data, the ML module 142 may generate a predictive function which maps outputs to inputs and may utilize the predictive function to generate ML outputs based upon data inputs. The exemplary inputs and exemplary outputs of the training data may include any of the data inputs or ML outputs described herein. In the exemplary embodiments, a processing element may be trained by providing it with a large sample of data with known characteristics or features.

In another embodiment, the ML module 142 may employ unsupervised learning, which involves finding meaningful relationships in unorganized data. Unlike supervised learning, unsupervised learning does not involve user-initiated training based upon exemplary inputs with associated outputs. Rather, in unsupervised learning, the ML module 142 may organize unlabeled data according to a relationship determined by at least one ML method/algorithm employed by the ML module 142. Unorganized data may include any combination of data inputs and/or ML model outputs.

In yet another embodiment, the ML module 142 may employ reinforcement learning, which involves optimizing outputs based upon feedback from a reward signal. Specifically, the ML module 142 may receive a user-defined reward signal definition, receive a data input, utilize a decision making model to generate the ML output based upon the data input, receive a reward signal based upon the reward signal definition and the ML output, and alter the decision making model so as to receive a stronger reward signal for subsequently generated ML outputs. Other types of ML may also be employed, including deep or combined learning techniques.

The ML module 142 may receive labeled data at an input layer of a model having a networked layer architecture (e.g., an artificial neural network, a convolutional neural network, etc.) for training one or more ML models. The received data may be propagated through one or more connected deep layers of the ML model to establish weights of one or more nodes, or neurons, of the respective layers. Initially, the weights may be initialized to random values, and one or more suitable activation functions may be chosen for the training process. The present techniques may include training a respective output layer of the one or more ML models.

The ML module 142 may comprise a set of computer-executable instructions to implement functionality such as loading, configurating, initializing, operating, and/or storing (e.g., in the memory 124, the database 126) the ML models 130. Once trained, one or more of the trained ML models 130 may be operated in inference mode, whereupon when provided with de novo input that the model has not previously been provided, the model may output one or more predictions, classifications, etc., as described herein.

In operation, the ML module 142 may access the memory 124, the database 126, and/or any other data source for training data (e.g., training data 126A) suitable to generate one or more ML models, such as the ML models 130. The training data may be sample data with assigned relevant and comprehensive labels (classes or tags) used to fit the parameters (weights) of the ML model with the goal of training it by example. In one aspect, once an appropriate ML model is trained and validated to provide accurate predictions and/or responses, the trained ML model may be loaded into the ML module 142 at runtime to process input data and generate output data.

While various embodiments, examples, and/or aspects disclosed herein may include training and generating the ML models 130 for the server 105 to load at runtime, one or more appropriately trained ML models may already exist (e.g., stored in the memory 124, the database 126) such that the server 105 may load the existing trained ML model 130 at runtime. The server 105 may retrain, fine-tune, update and/or otherwise alter an existing ML model 130 before and/or after loading the ML model 130 at runtime. Although the ML model 130 may be described as being trained and operated (e.g., via ML module 142) on the server 105, in at least one embodiment the ML model 130 may be trained on the server 105 (e.g., or other computing device), and operated on another server (or another computing device).

The computing modules 140 may include an input/output (I/O) module 144, comprising a set of computer executable instructions implementing communication functions. The I/O module 144 may include a communication component configured to communicate (e.g., send and receive) data via one or more external/network port(s) to one or more networks or local terminals, such as the network 110 described herein. The I/O module 144 may include or implement a user interface configured to present information to an administrator, operator or other user, and/or receive inputs from the user, such as via a touchscreen display. The I/O module 144 may facilitate I/O components (e.g., ports, capacitive or resistive touch sensitive input panels, keys, buttons, lights, LEDs), which may be directly accessible via, or attached to, the server 105 and/or may be indirectly accessible via, or attached to, another device. According to one aspect, a user may access the server 105 via a user interface to input and/or review data/information, initiate ML model training via the ML module 142, and/or perform other functions, such as functions associated with generating slides.

The network 110 may include one or more networks, including a local area network (LAN), wide area network (WAN), the Internet, a combination thereof, and/or any other suitable network. Generally, the network 110 enables bidirectional communication between the server 105, the computing device 115, and other components and/or devices of the computing environment 100. In some embodiments, the network 110 may comprise a cellular base station, such as cell tower(s), communicating to the one or more components of the computing environment 100 via wired/wireless communications based upon any one or more of various mobile phone standards, including NMT, GSM, CDMA, UMTS, LTE, 5G, 6G, or the like. Additionally, or alternatively, the network 110 may comprise one or more routers, wireless switches, or other such wireless connection points communicating to the components of the computing environment 100 via wireless communications based upon any one or more of various wireless standards, including by non-limiting example, IEEE 802.11 a/ac/ax/b/c/g/n (Wi-Fi), Bluetooth, and/or the like.

The server 105 may also be in communication with at least one computing device 115, which may be referred to at times as a “user device.” The computing device 115, may request information/data from, and/or provide information/data to, the server 105 and/or other components of the computing environment 100. The computing device 115 may access services and/or other components of the computing environment 100 via the network 110. The computing device 115 may include a computer (e.g., desktop computer, laptop computer, terminal, server), a mobile device, a wearable, augmented reality glasses/headsets, virtual reality glasses/headsets, mixed or extended reality glasses/headsets, and/or other suitable computing device. The computing device 115 may include a processor 146 (e.g., the processor 120) and a memory 148 (e.g., the memory 124) for storing and executing one or more applications, modules, computer-executable instructions, etc. The computing device 115 may further include a network interface 152 (e.g., the network interface 122) and a display 154 (e.g., LCD, LED, OLED, head-mounted, etc.).

In at least some embodiments, the memory 148 of the computing device 115 stores a Slide Generator client application 150. The Slide Generator client application 150 may be configured to provide the same and/or similar functionality as the Slide Generator application 128, and/or be communicatively connected (e.g., via the network 110) to the Slide Generator application 128 to provide the functionality of the Slide Generator application 128 to the user of the Slide Generator client application 150. In one example, the Slide Generator client application 150 may be a mobile device application to generate slides locally on the computing device 115. In another example, the Slide Generator client application 150 may communicate with the Slide Generator application 128 via the network 110 to generate slides at the server 105.

In some embodiments, the computing environment 100 may generate slides using ML. In at least some embodiments, the server 105 may execute the Slide Generator application 128 to generate a new slide using ML. It should be understood that one or more actions performed by the Slide Generator application 128 may be carried out via the server 105 and/or otherwise computing device executing the Slide Generator application 128. For example, the Slide Generator application 128 may be described as obtaining data to provide to one of the ML models 130, which may include the server 105 obtaining the data from the database 126, executing the ML module 142 causing the ML module 142 to load one of the ML models 130 from the memory 124 for execution, and also provide the data to the ML model 130.

The Slide Generator application 128 may obtain content data indicating content of a new slide that the Slide Generator application 128 will generate. For example, the new slide content may include and/or indicate the text of the slide (e.g., structured text, unstructured text), elements of the slide (e.g., text boxes, chevrons, etc.), and/or any other suitable content. In one example, the server 105 may obtain the content data from a model, such as an LLM (e.g., the LLM 132) that is fine-tuned to generate slide content. In another example, a user may provide the slide content via the Slide Generator application 128, for example by answering one or more questions provided to the user via the Slide Generator application 128. In another example, the content data may be retrieved from storage (e.g., the memory 124, the database 126) and/or from another device (e.g., another server 105, the computing device 115).

The Slide Generator application 128 may generate a first prompt for the LLM 132 to generate a description of a layout of the new slide based upon the content of the new slide. The first prompt may include, for example: “Generate a description of the perfect layout that would best display the new slide content.” The Slide Generator application 128 may provide the first prompt to the LLM 132 as an input. Providing one or more prompts to the LLM 132 from the Slide Generator application 128 may include providing the prompt to the LLM 132 executed locally on the server 105 (e.g., via the ML module 142) or transmitting the prompt to the LLM 132 via the network 110, for example when the LLM 132 is executed on a device (e.g., another server 15, the computing device 115) remote from the server 105.

In response to the LLM 132 receiving the first prompt, the LLM 132 may generate new slide layout data including the description of the layout of the new slide. The description of the new slide layout, for example, may describe the ideal slide layout for the content of the new slide. This may include describing a layout for a four-step process, the layout including a title text box centered at the top of the slide (e.g., the title text box including extra-large font text for the title of the process), four header text boxes located below the title text box (e.g., each of which includes large font text associated with one of the four steps), and four large description text boxes with each large text box located below the associated header text box (e.g., for medium font text to describe the step indicated by the associated header). However, the slide layout data may include any suitable data and/or description of the layout of the new slide for the new slide content.

The Slide Generator application 128 may obtain template slide layout data. The template slide layout may include a description of the layout of multiple template slides, similar to the new slide layout data that described the layout of the new slide. In at least some embodiments, the layout-mapping model 136 generates the template slide layout data based upon receiving template slide metadata for the template slides as well as template slides image data comprising an image of each of the template slides. The metadata for a slide, such as template slide metadata, may indicate layout characteristics of one or more elements of the slide, such as the type of element (e.g., a text box), the element size (e.g., large text box), a font type of the element, the location of the element in the slide (e.g., coordinates of the element), and or any other suitable layout characteristic of an element of a slide. The Slide Generator application 128 may cause the layout-mapping model 136 to generate the template slide layout data (e.g., via the ML module 142), may retrieve the template slide layout data from storage (e.g., the memory 124, the database 126) and/or another device (e.g., another server 105, the computing device 115), and/or obtain the template slide layout data in any other suitable manner.

Based upon the new slide layout data and the template slide layout data, the Slide Generator application 128 may determine a subset of template slides that have layouts (e.g., as described in the template slide layout data) similar to the layout of the new slide (e.g., as described in the new slide layout data). In at least some embodiments, determining the subset of template slide may include embedding the descriptions of the new slide layout and the template slide layouts, although the subset of slide may be determined in any suitable manner. The embedding may be performed by a sentence transformer model such as all-mpnet-base-v2. The Slide Generator application 128 may then perform a similarity search using cosine similarity to determine and/or otherwise identify the subset of template slides. In at least some embodiments, the Slide Generator application 128 may determine one or more categories of the plurality of template slides, and determining the subset of template slides may be based upon the categories of the template slides. For example, one category may include a template slide layout for a six-step method, and if the new slide layout indicates a six-step method, the template slides categorized as having a layout for the six-step method may be selected as the subset of template slides. In at least some embodiments, the template recommendation model 134 determines the subset of template slides based upon receiving the new slide layout data and the template slide layout data for the template slides as an input.

The Slide Generator application 128 may generate a second prompt for the LLM 132 to select and/or recommend a template slide of the subset of template slides best suited for the content. The second prompt may include, for example: “You are an expert slide designer. Choose a layout of a template slide from the layouts of the subset of template slides that would most effectively display the new slide content.” The selected template slide may be used as a template for generating the new slide. In response to receiving the second prompt from the Slide Generator application 128, the LLM 132 may cause the template recommendation model 134 to select and/or recommend the template slide based upon receiving (e.g., via the LLM 132, the Slide Generator application 128, etc.) the content data and the template slide layout data of the subset of template slides as an input. Of the subset of template slides, the template slide selected may have a layout most similar to the layout of the new slide, and/or based on any other consideration.

In at least some embodiments, rather than determining a subset of template slides and having the selection model 134 select and/or recommend the template slide from the subset of template slide, the selection model 134 may select the template slide from all template slides, for example based upon receiving the content data and the template slide layout data of all the template slides. In another embodiment, a user may select the template slide (e.g., from all template slides, the subset of template slides) via a user interface of the server 105. For example, the Slide Generator application 128 may cause the server 105 to display a graphical user interface (GUI) on a display (e.g., the display 154) of the server, and/or a display of a computing device (e.g., the computing device 115) communicative connected (e.g., via the network 110) to the server 105. The GUI may display multiple template slides and receive a selection from the user (e.g., via an input device such as a mouse, touchscreen, keyboard, etc.) of the template slide.

The Slide Generator application 128 may obtain template slide metadata for the template slide. The template slide metadata may indicate layout characteristics of one or more elements of the template slide, as previously described. The Slide Generator application 128 may generate the template slide metadata by scraping metadata from the template slide data/file (e.g., a PowerPoint® file). For example, if the template slide is stored in memory (e.g., the memory 124) as a Microsoft PowerPoint® file, the Slide Generator application 128 may scrape metadata from the PowerPoint file using python-pptx. It at least some embodiments, the Slide Generator application 128 may obtain the template slide metadata from storage (e.g., the memory 124, the database 126) and/or another computing device (e.g., another server, the computing device 115). The Slide Generator application 128 may obtain template slide image data comprising an image of the template slide. The Slide Generator application 128 may generate an image of the template slide (e.g., via a screenshot, PDF, JPEG, etc., of the template slide displayed via the Slide Generator application 128), retrieve the template slide image from storage (e.g., the memory 124, the database 126) and/or another computing device (e.g., another server, the computing device 115), and/or obtain the template slide image in any other suitable manner.

The Slide Generator application 128 may generate a third prompt for the LLM 132 to generate a mapping of the one or more elements of the template slide including a description of the one or more elements of the template slide. The third prompt may include, for example: “Provide a template slide mapping including an identification and description of each element.” The description of an element may include one or more of an element identifier, a type of content of the element, a shape of the element, a text capacity of the element, and/or any other suitable element description. For example, the element identifier may be indicated in the metadata of a slide (e.g., by the slide software vendor such as Microsoft PowerPoint®) and/or allow the Slide Generator application 128 to insert the new slide content into the appropriate, corresponding slide element.

In response to the LLM 132 receiving the third prompt, the Slide Generator may generate template slide element mapping data including the description of the one or more elements of the template slide by applying the layout-mapping model 136 to the template slide metadata and the template slide image data. For example, the template slide element mapping data may include information such as element 001 is an extra-large rectangular text box for a title centered at one inch from the top of the slide and holds one sentence, element 002 is a large text box for a sub-title centered one inch below element 001 and holds one sentence, elements 003, 004 are text boxes for main steps of a process with elements 003, 004 located two inches below element 002 with three inches between elements 003, 004 and elements 003, 004 hold 8-12 words each, etc.

The Slide Generator application 128 may generate a fourth prompt for the LLM 132 to generate the new slide based on the content and the description of the one or more elements of the template slide. In response to the LLM 132 receiving the fourth prompt, the Slide Generator application 128 may generate the new slide by applying the slide generator model 138 to the template slide element mapping data and the content data. Generating the new slide may include generating a mapping (e.g., element mapping, schema) of the content to the one or more elements of the template slide. For example, the Slide Generator application 128 may open the template slide and iteratively insert the appropriate content into each slide element, until all requisite slide elements are populated with content. The mapping may generate a JavaScript Object Notation (JSON) file that indicates the new slide content (e.g., the content text) to populate into each template slide element (e.g., using the element identifier). Generating the new slide may include populating the one or more elements with the content based upon the mapping. For example, the title of the new slide indicated by the content data may be mapped to the title text box of the template slide, and the title may then be populated into the title text box.

The Slide Generator application 128 may store the new slide (e.g., as a file) in the memory 124, the database 126, and/or other suitable storage. The Slide Generator application 128 may display, at a user interface (e.g., the display 154) of a computing device (e.g., the 105, the computing device 115), the new slide. For example, if the computing device 115 is accessing the Slide Generator application 128 remotely at the server 105 via the network 110, the Slide Generator application 128 may transmit the new slide to the computing device 115 via the network 110 for the computing device 115 to display the new slide on the display 154.

For at least one of the ML models 130, the server 105 may update and/or retrain the ML model 130, for example to improve the performance of the ML model 130. The server 105 may obtain updated training data 126A, and retrain (e.g., via the ML module 142) the respective ML model 130 using at least a portion of the updated training data 126A. One or more of the inputs and/or outputs of the ML models 130 may be stored as updated training data 126A to train the ML models 130, as further described below. The Slide Generator application 128, the server 105, the computing device 115, and/or other suitable device or component of the computing environment 100 may store the updated/retrained ML model 130 in a memory, such as the memory 124, the database 126, etc., to perform subsequent operations.

It should be understood that although the systems, methods and techniques disclosed herein generally describe generating a single slide, the systems, methods and techniques may be applied to generate any number of slides, and/or other visual content (e.g., a poster, an infographic, a magazine cover, a newspaper or website layout, etc.). Moreover, LLM prompts described as a single prompt may include multiple prompts in other embodiments. In one example, rather than using a single (e.g., fourth) prompt for the LLM 132 to generate the new slide, the disclosed techniques may implement multiple LLM prompts to improve the quality of the new slide, e.g., using prompt engineering. In another example, a first LLM prompt may generate a template slide element mapping, and additional LLM prompts may refine template slide element mapping to correct any inaccuracies or enrich the mapped content to better fit the character limits of a textbox.

It should also be understood that, while the computing environment 100 is shown in FIG. 1 to include one each of the server 105, the network 110, and the computing device 115, different numbers of servers 105, networks 110 and/or computing devices 115 may be utilized. In one example, the computing environment 100 may include hundreds of servers 105 all of which may be interconnected via the network 110 to communicate with hundreds of computing devices 115.

The computing environment 100 may include additional, fewer, and/or alternate components, and may be configured to perform additional, fewer, or alternate actions, including components/actions described herein. For example, although the server 105 is shown in FIG. 1 as including one instance of various components such as the processor 120, the memory 124 and the database 126, various aspects include the computing environment 100 and/or the server 105 implementing any suitable number of any of the components shown in FIG. 1 and/or omitting any suitable ones of the components shown in FIG. 1. For instance, information described as being stored in the memory 124 may be stored in the database 126, and therefore the memory 124 may be omitted. Furthermore, it should be appreciated that additional and/or alternative connections between components shown in FIG. 1 may be implemented. As just one example, server 105 may be connected to the database 126 via the network 110 rather than being locally connected to one another via a direct connection as illustrated in FIG. 1.

### Exemplary ML Model Training

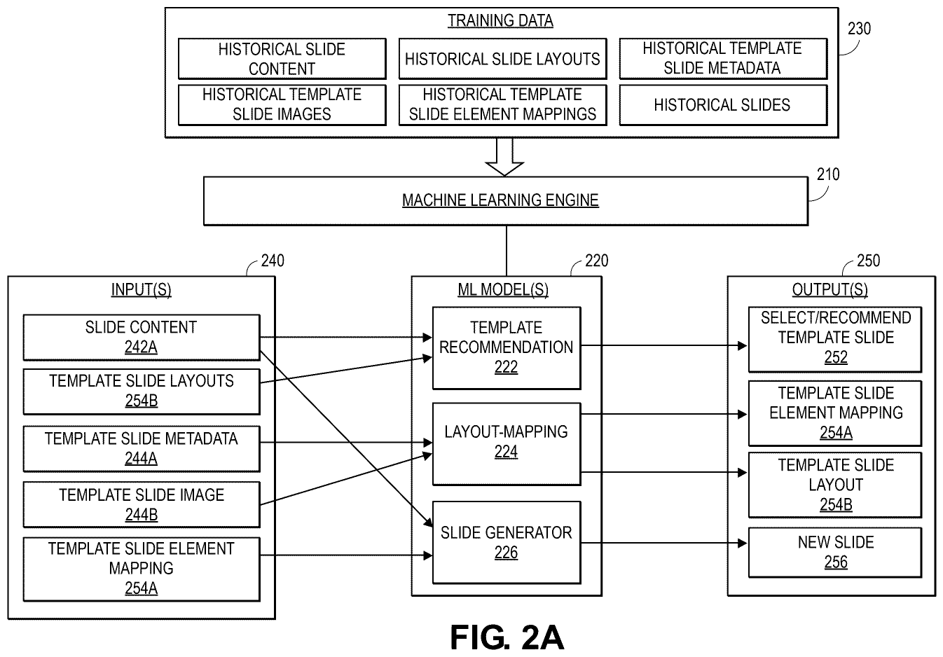

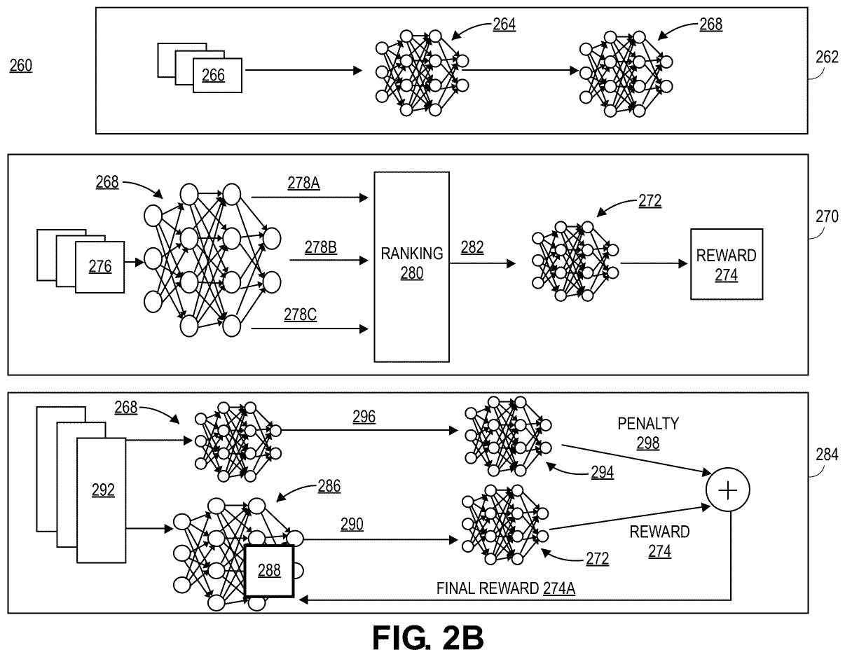

FIG. 2A depicts a combined block and logic diagram for training an exemplary machine learning model, according to some embodiments. More specifically, an ML engine 210 (e.g., the ML module 142) trains one or more ML models 220 (e.g., the ML models 130) using training data 230 (e.g., the training data 126A). The trained ML models 220 are applied to, and/or receive, at least one input 240 and generate at least one output 250. It should be understood that the techniques described with regard to FIG. 2A may apply to training the ML models 220, however the ML models 220 may be trained in accordance with any of the other techniques described herein, and it should be understood the training of the ML models 220 should not be considered restricted to the teachings of FIG. 2A.

An ML engine 210 may include one or more hardware and/or software components to obtain, create, (re)train, operate, fine-tune, and/or store the ML models 220. A server (e.g., the server 105), may obtain and/or have available (e.g., stored in the database 126) one or more types of training data 230 for model creation, training, retraining and/or fine-tuning (generally referred to herein as “training”). In at least one aspect, at least some of the training data 230 may be labeled to aid in training the ML models 220. The ML engine 210 may process and/or analyze the training data 230 to learn associations and/or relationships in the training data 230, and configure the ML models 220 to process the training data 230 such that when one of the ML models 220 receives one or more inputs 240, it generates appropriate output(s) 250. The ML models 220 may be trained via regression, k-nearest neighbor, support vector, random forest, and/or via any other suitable model training method and/or algorithm, including training using one or more of supervised learning, unsupervised learning, semi-supervised learning, and/or reinforcement learning. In at least one aspect, at least one of the ML models 220 may be considered as successfully trained when able to achieve one or more metrics (e.g., a score indicating accuracy) associated with its performance when processing the training data 230. Once trained, the ML engine 210 may load one or more of the ML models 220 at runtime to perform operations on one or more data inputs 240 to produce the desired data output 250.

In at least some embodiments, the ML models 220 may include a template recommendation model 222 (e.g., the template recommendation model 134) trained to select and/or recommend a template slide 252 as an output 250 based on receiving slide content 242A of a new slide and template slide layouts 254B of a plurality of template slides (e.g., template slide layouts for a subset of template slides) as inputs 240. The training data 230 may include template recommendation model training data to train the template recommendation model 222. The template recommendation model training data may include historical slides having historical content, historical slide layouts of historical template slides, and/or any other suitable template recommendation model training data. The ML engine 210 may train the template recommendation model 222 to learn associations and relationships in the template recommendation model training data such that when receiving the slide content 242A of a new slide and the template slide layouts 254B as the inputs 240, the template recommendation model 222 can successfully select and/or recommend the template slide 252 best suited to display the slide content 242A as the desired output 250. For example, the template recommendation model training data may include historical slides having historical layouts for displaying historical content for a six-step process, and historical template slides having historical layouts similar to, and/or historical layouts used to create, the historical slides displaying the six-step process. The template recommendation model 222 may be trained to determine slide layouts best suited to display certain types of slide content, the template slides having layouts most similar to a slide layout best suited for certain types of slide content, among other things. Once trained, the template recommendation model 222 may receive the new slide content 242A for a six-step process and the template slide layout 254B of template slides, and select and/or recommend a template slide 252 having a layout best suited to display the new slide content 242A for the six-step process.

In at least some embodiments, the ML models 220 may include a layout-mapping model 224 (e.g., the layout-mapping model 136) trained to generate a template slide element mapping 254A of a template slide as an output 250 based upon receiving template slide metadata 244A indicating layout characteristics of elements the template slide and a template slide image 244B as inputs 240. The training data 230 may include layout-mapping model training data to train the layout-mapping model 224. The layout-mapping model training data may include historical template slides including historical elements, historical template slide metadata of the historical template slides, historical template slide images of the historical slides, historical template slide mappings of the historical slides, historical temple slide layouts of the historical slides, and/or any other suitable layout-mapping model training data. The ML engine 210 may train the layout-mapping model 224 to learn associations and relationships in the layout-mapping model training data such that when receiving the slide metadata 244A and slide image 244B of a template slide as the inputs 240, the layout-mapping model 224 can successfully provide a template slide element mapping 254A describing the one or more elements of the template slide as the desired output 250. Returning to the previous example, the layout-mapping model training data may include historical template mappings describing text box elements of historical template slides having layouts suited to display a six-step process. The historical template elements may include a title text box (e.g., for the title of a six-step process), six header texts boxes (e.g., for the title of each process step), and six description text boxes (e.g., to describe each process step). The associated historical template slide metadata may indicate the quantity, size, font (e.g., font type and font size), and locations of the thirteen text boxes, and the associated historical slide images may visually depict the historical template slides including the thirteen text boxes. The layout-mapping model 224 may be trained to describe elements of a template slide based upon the visual depictions of the elements and their associated layout characteristics. Once trained, the layout-mapping model 224 may receive the template slide metadata 244A and a template slide image 244B of the template slide having the thirteen text boxes for a six-step process, and generate the template slide element mapping 254A of the template slide that describes the type of content, shapes, text capacities, etc. of the thirteen text boxes of the template slide.

In at least some embodiments, the layout-mapping model 224 may be trained to generate the template slide layout data 254A including a description of the layout of the template slide as an output 250 based upon receiving template slide metadata 244A indicating layout characteristics of elements the template slide and a template slide image 244B as inputs 240. The layout-mapping model 224 may be trained to describe the layout of a template slide based upon the visual depictions of the elements and their associated layout characteristics.

In at least some embodiments, the ML models 220 may include a slide generator model 226 (e.g., the slide generator model 138) trained to generate a new slide 256 as an output 250 based upon receiving the new slide content 242A and the template slide mapping 254A as inputs 240. The training data 230 may include slide generator model training data to train the slide generator model 226. The slide generator model training data may include the historical slide content, historical slide template mappings, historical slides having the historical content populated into elements of historical template slides, and/or any other suitable slide generator model training data. The ML engine 210 may train the slide generator model 226 to learn associations and relationships in the slide generator model training data such that when receiving the new slide content 242A and the template slide mapping 254A as inputs 240, the slide generator model 226 can successfully generate the new slide 256 as the desired output 250. Retuning yet again to the previous example, the slide generator model training data may include historical slides including historical content for a six-step process, the historical content being populated in elements of the historical slides. The slide generator model training data may also include associated historical template mappings for historical template slide elements associated with a six-step process. The slide generator model 226 may learn associations between slide content and template slide elements best suited to receive the slide content such that when receiving new slide content 242A for a six-step process and the template mapping 254A for thirteen elements of a template slide for receiving the slide content 242A, the slide generator model 226 generates the new slide 256 by populating the six-step process title from the slide content 242A into the title text box of the template slide, populates the title for each of the six steps from the slide content 242A into respective six header boxes of the template slide, and populates the descriptions of each of the six steps from the slide content 242A into respective six description text boxes of the template slide.

The server and/or the ML engine 210 may update at least a portion of the training data 230 at one or more times. For example, the server and/or ML engine 210 may store (in the memory 124 or the database 126) the new slide content 242A and template slide layouts 254B input to the template recommendation model 222, as well as the selected template slide 252 output by the template recommendation model 222 as updated template recommendation model training data. One or more of the ML models 220 may be retrained based upon at least a portion of the updated training data 230. The retrained/updated ML models 220 may be stored in memory, and subsequently executed to generate improved outputs based upon the retraining. The retraining process may cause the output 250 of the ML models 220 to improve over time. Continuing with the previous example, the slide content 242A may be an organization chart for a business and the selected template slide 252 may be the second best slide layout 254B of all template slides to display the organization chart. Using the updated template recommendation model training data, the template recommendation model 222 may be retrained to learn the template slide layout 254B that is best suited for the organization chart such that when the template recommendation model 222 receives new slide content 242A for a similar organization chart, the template recommendation model 222 selects the template slide 252 having the layout best suited for the organization chart, improving the output 250 of the template recommendation model 222.

In at least some embodiments, reinforcement learning may be used to update one or more models 220. For example, users may provide feedback indicating templates they most prefer or find the most useful, and the feedback (e.g., a popularity metric) may be used to bias/reinforce recommendations and/or selections of the template recommendation model 222.

It should be understood that functionality attributed to a single model may be performed by two or more models, and conversely functionality attributed to multiple models may be performed by a single model. For example, in addition to generating template slide element mapping data, the layout-mapping model 224 may be able to generate the new slide that is otherwise attributed to the slide generator model 226

### Example Generative AI

One or more machine learning models (e.g., the LLM 132, the ML models 220) may be a generative model and/or include generative functionality that allows the machine learning model 220 to generate new content, such as images, text, slides, or other forms of data, that is similar to, or inspired by, existing examples. Generative models operate on principles derived from machine learning, as previously described.

In some embodiments, the generative model may be or include a Generative Adversarial Network (GAN). In some embodiments, GANs consist of two neural networks—the generator and the discriminator—that are trained in tandem through adversarial training. The generator aims to create data that is indistinguishable from real examples, while the discriminator's role is to differentiate between genuine and generated data. As part of the adversarial training, the generator and the discriminator iteratively compete and improve, and the generator becomes adept at producing increasingly realistic content.

In further embodiments, the machine learning model may include and/or be trained with Recurrent Neural Networks (RNNs) or transformers, which are used for sequential data generation, such as natural language text. These models learn patterns and dependencies in their training data and can then generate new sequences by predicting the next element based on the context provided. In at least some aspects, the machine learning model (e.g., the LLM 132) may be trained to generate responses to prompts/requests including natural language, as further described below.

### Example LLM

The present techniques may include language modeling via one or more LLMs wherein one or more models (e.g., deep learning models) are trained by processing token sequences using an LLM architecture. For example, a transformer architecture may be used to process a sequence of tokens. The transformer model may include a plurality of layers including self-attention and feed-forward neural networks. The transformer architecture may enable the model to learn contextual relationships between the tokens, and to predict the next token in a sequence, based upon the preceding tokens. During training, the model is provided with the sequence of tokens and it learns to predict a probability distribution over the next token in the sequence. The training process may include updating one or more model parameters (e.g., weights or biases) using an objective function that minimizes the difference between the predicted distribution and a true next token in the training data.

Alternatives to the transformer architecture may include recurrent neural networks, long short-term memory networks, gated recurrent networks, convolutional neural networks, recursive neural networks, and other modeling architectures.

In some aspects, the machine learning engine 210 may include instructions for performing pretraining of a language model which generally refers to a process that may span pre-processing of training data and initialization of an as-yet untrained language model. In general, a pre-trained model is one that has no prior training of specific tasks. For example, the model pretraining module may include instructions that initialize one more model weights. In some aspects, machine learning engine 210 may initialize the weights to have random values. The pretraining may train one or more models using unsupervised learning, wherein the one or more models process one or more tokens (e.g., preprocessed data) to learn to predict one or more elements (e.g., tokens). The pretraining may include one or more optimizing objective functions that the model pretraining module applies to the one or more models, to cause the one or more models to predict one or more most-likely next tokens, based on the likelihood of tokens in the training data. In general, the model pretraining causes the one or more models to learn linguistic features such as grammar and syntax. The pretraining may include additional steps, including training, data batching, hyperparameter tuning, and/or model checkpointing.

The model pretraining may include instructions for generating a language model that is pretrained for a general purpose, such as general text processing and/or language understanding. This model may be known as a “base model” in some aspects. The base model may be further trained by downstream training process(es), for example via the machine learning engine 210. Pretraining may be a distinct stage of model training in which training data of a general and diverse nature (i.e., not specific to any particular task or subset of knowledge) is used to train the one or more models. In some aspects, a single model may be trained and copied to provide a plurality of base which are subsequently fine-tuned to become a plurality of fine-tuned models. In this way, the base model can start from a relatively advanced stage, without requiring pretraining of each more advanced model individually.

In some aspects, base models may be trained to have specific levels of knowledge. For example, a base language model such as a general-purpose pretrained LLM (e.g., GPT4) may be subsequently trained/fine-tuned with data associated with terminology to describe slide elements to become a fine-tuned language model able to generate template slide mappings describing elements of template slide.

### Example LLM Training

As previously described, the LLM (e.g., the LLM 132) may be capable of understanding prompts/requests and generating relevant data/information responsive to the prompts/requests. Additionally, the LLM may generate data from interactions which may be used to retrain the LLM and improve its functionality. The LLM may be trained by any suitable component (e.g., the machine learning module 142, the machine learning engine 210, etc.) using large training datasets of text, which may provide sophisticated capability for natural-language tasks, such as answering questions and/or holding conversations. The LLM may include a general-purpose pretrained LLM as described above which, when provided with a starting set of words (e.g., a prompt) as an input, may attempt to provide an output (e.g., a response) of the most likely set of words that follow from the input.

In at least some aspects, the prompt may be provided to, and/or the response received from, the LLM and/or any other machine learning model via a user interface. For example, the server 105 and/or computing device 115 may provide a user interface, such as a graphical user interface which the Slide Generator application 128 generates. The user interface may be configured to receive input from, and provide output to (e.g., via the I/O module 144), one or more user interface devices, such as a touchscreen, a keyboard, a mouse, a microphone, a speaker, a display (e.g., the display 154), and/or any other suitable user interface devices.

Multi-turn (i.e., back-and-forth) conversations may require the LLM to maintain context and coherence across multiple user utterances to keep track of an entire conversation history as well as the current state of the conversation, for example via the use of short-term and long-term memory. Short-term memory may temporarily store information (e.g., in the memory 124) that may be required for immediate use and may keep track of the current state of the conversation and/or to understand the user's latest input in order to generate an appropriate response. Long-term memory may include persistent storage of information (e.g., in the memory 124, the database 126, etc.) which may be accessed over an extended period of time.

FIG. 2B depicts a combined block and logic diagram 260 for training an exemplary LLM (e.g., the LLM 132), according to some embodiments. It should be understood that the techniques described with regard to FIG. 2B may apply to training the LLM, however the LLM may be trained in accordance with any of the other techniques described herein, and it should be understood the training of the LLM should not be considered restricted to the teachings of FIG. 2B.

In some embodiments, the system and methods to generate and/or train the LLM (e.g., via the ML engine 210) may include multiple steps. The first step of block 262 may be a supervised fine-tuning (SFT) step where a pretrained language model 264 (e.g., a publicly available pretrained LLM such as Google PaLM 2) may be fine-tuned on a supervised training dataset 266. In the supervised training dataset 266, each data input prompt to the pretrained language model 264 may have a known output response for the pretrained language model 264 to learn from. In some embodiments, data labelers, for example, may create the supervised training dataset 266 wherein each data input prompt to the pretrained language model 264 may have a known output response. The pretrained language model 264 may learn a supervised policy to generate responses/outputs from a selected list of prompts/inputs to generate a SFT ML model 268. The SFT machine learning 268 may provide appropriate responses to user prompts once trained, and may represent a cursory model for what may be later developed and/or configured as the LLM.

The second step 270 of block 270 may be a reward model step where human labelers may rank numerous responses output by the SFT machine learning model 268 to evaluate the responses which best mimic preferred human responses, thereby generating comparison data. A reward model 272 may be trained on the comparison data to provide, as an output, a scaler value/reward 274. The reward model 272 may leverage reinforcement learning from human feedback in which the SFT ML model 268 learns to produce outputs which maximize its reward 274, and in doing so may provide responses which are better aligned to user prompts.

Training the reward model 272 may include, at block 270, providing a single prompt 276 (e.g., via a user interface) to the SFT machine learning model 268 as an input. The input prompt 276 may be previously unknown to the SFT machine learning model 268, for example the labelers may generate new prompt data, the prompt 276 may be included in testing data stored in memory (e.g., the database 126), and/or any other suitable prompt data. The SFT machine learning model 268 may generate multiple, different output responses 278A, 278B, 278C in response to the single prompt 276. The responses 278A-278C may be output for review by the data labelers via any suitable technique, such as via a display (e.g., the display 154) as text responses, a speaker as audio/voice responses, etc. The data labelers may provide feedback (e.g., via a user interface, etc.) on the responses 278A-278C by ranking 280 the responses 278A-278C (e.g., using data labeling) from best to worst based upon the prompt-response pairs. The ranked prompt-response pairs 282 may be the comparison data used to train the reward model 272 to generate the scalar reward 274. In some aspects, the scalar reward 274 may include a value numerically representing a human preference for the best and/or most expected response to a prompt, i.e., a higher scaler reward value may indicate the user is more likely to prefer that response, and a lower scalar reward may indicate that the user is less likely to prefer that response. For example, inputting the “winning” prompt-response (i.e., input-output) pair data to the reward model 272 may generate a “winning” scalar reward 274 with a higher value than a “losing” scalar reward 274 from a “losing” prompt-response pair data.

For example, during training the SFT ML 268 may receive an example prompt 276 to “Generate a description of the perfect slide layout that would best display content for a three-step process, where the first step includes downloading a driver for a web camera, the second step includes installing the software driver on a computer, and the third step include connecting the web camera to a USB port on the computer.” The SFT ML 268 may generate multiple responses. A first example response 278A may include “the perfect slide layout would include a title text box for the title of the process, and three description text boxes for descriptions of the three process step.” A second example response 278B may include “the perfect slide layout would include three header text boxes for titles of the three process step, and three description text boxes for descriptions of the three process step.” A third example response 278C may include “the perfect slide layout would include a title text box for the title of the process, three header text boxes for titles of the three process step, and three description text boxes for descriptions of the three process step.” The data labeler may rank 280, via labeling the prompt-response pairs, prompt-response pair 276/278C as the most preferred answer; prompt-response pair 276/278B as a less preferred answer; and prompt-response 276/278C as the least preferred answer. The ranked prompt-response pairs 282 may each be provided to the reward model 272 to generate the associated scalar reward 274 for each prompt-response.

The third step block 284 may be a policy optimization step in which the reward model 272 may further fine-tune and improve the SFT machine learning model 268. The outcome of fine-tuning the SFT machine learning model 268 may be the LLM 286. The computing device 115 may train the LLM 286 (e.g., via the ML engine 210) to generate a response 290 to a random, new and/or previously unknown prompt 292. To generate the response 290, the LLM 286 may use a policy 288 (e.g., algorithm) developed during training of the reward model 272. The policy 288 may represent a strategy for the LLM 286 to maximize its reward 274. One or more rewards 274 may feed back into the LLM 286 to evolve the policy 288, for example when having human labelers provide continuous feedback associated with how well the responses 290 of the LLM 286 match expected responses. During the feedback process, the policy 288 may adjust the parameters of the LLM 286 as provides responses 290 to additional prompts 292 based upon the rewards 274 it receives for generating good responses. In some embodiments, the responses 290 of the LLM 286 using the policy 288 based upon the reward 274 to the prompt 292 may be compared to the responses 296 of the SFT machine learning model 268 (which may not use a policy) to the same prompt 292 using a penalty function 294. A penalty 298 may be computed based upon the penalty function 294 of the responses 290, 296. The penalty 298 may reduce the distance between the responses 290, 296, i.e., a statistical distance measuring how one probability distribution is different from a second, in some aspects the response 290 of the LLM 286 versus the response 296 of the SFT model 268. Using the penalty 298 to reduce the distance between the responses 290, 296 may over-optimizing the reward model 272 and deviating too drastically from the human-intended/preferred response. Without the penalty 298, during optimization the LLM 286 may generating responses 290 which are unreasonable but may still result in the reward model 272 outputting a high reward 274.

In some aspects, the responses 290 of the LLM 286 using the current policy 288 may be passed to the reward model 272, which may return the scalar reward 274. The LLM 286 response 290 may be compared via the penalty function 294 to the SFT machine learning model 268 response 296 to compute the penalty 298. A final reward 274A may be generated which may include the scalar reward 274 offset and/or restricted by the penalty 298. The final reward 274A may be provided to the LLM 286 and may update the policy 288, which in turn may improve the functionality of the LLM 286.

To optimize the LLM 286 over time, reinforcement learning from human feedback via the human labeler feedback may continue ranking 280 responses of the LLM 286 versus outputs of earlier/other versions of the SFT machine learning model 268 providing positive or negative rewards 274. The reinforcement learning from human feedback process may allow the LLM 286 training process to continue iteratively updating the reward model 272 and/or the policy 288. As a result, the LLM 286 may be retrained and/or fine-tuned based upon the human feedback via the reinforcement learning from human feedback process, and throughout continuing conversations may become increasingly efficient.

In some aspects, the steps of block 262 may take place only once, while steps of block 270 and/or block may be iterated continuously, e.g., more comparison data is collected to optimize/update the reward model 272 and/or further optimize/update the policy 288.

Although multiple blocks 262, 270, 284 are depicted in the example block and logic diagram 260, fewer and/or additional blocks may be utilized and/or may provide the steps to train the LLM 286. In some variations, each block 262, 270, 284 represents one or more servers (e.g., each server performs a different training stage, etc.) or other computing device 115.

### Exemplary Slide Generation

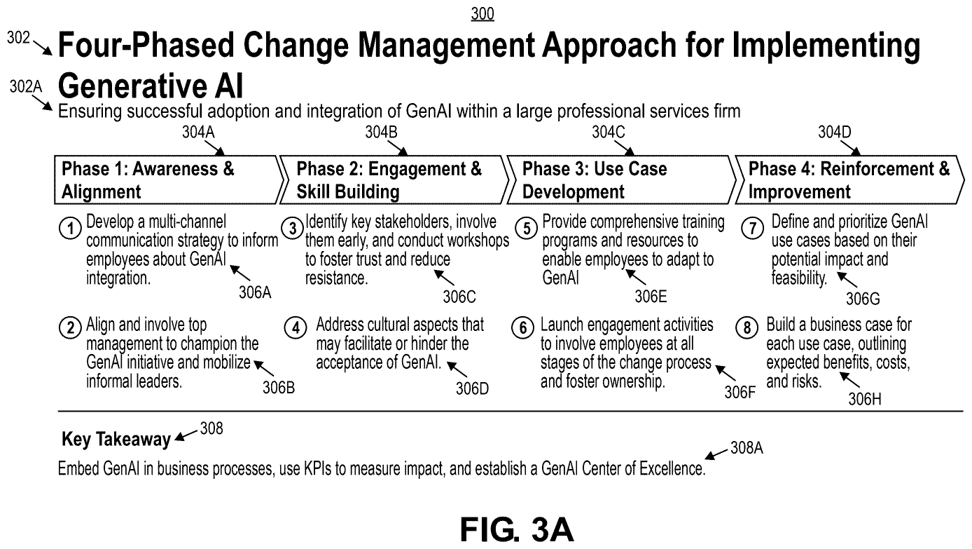

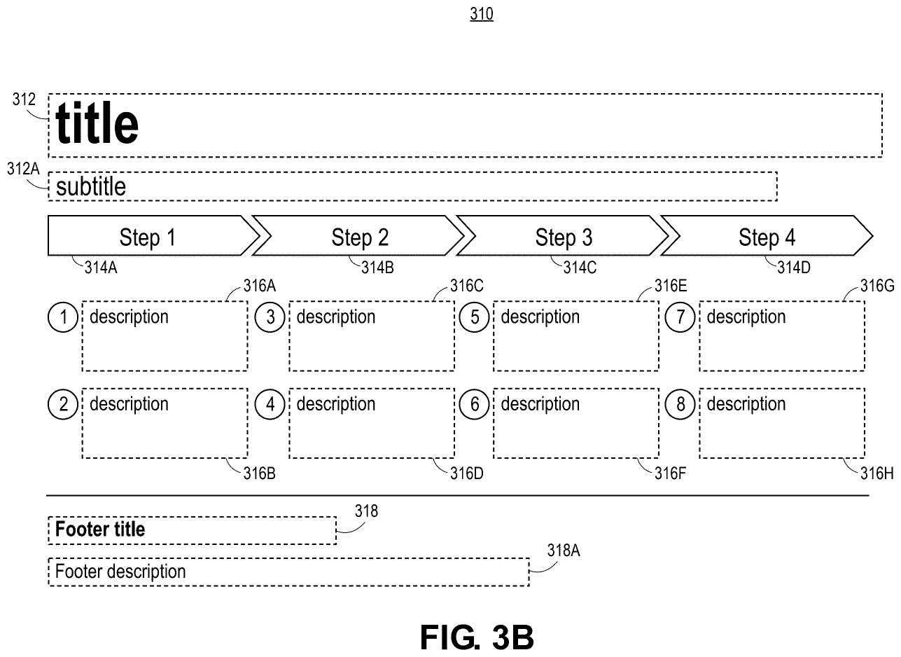

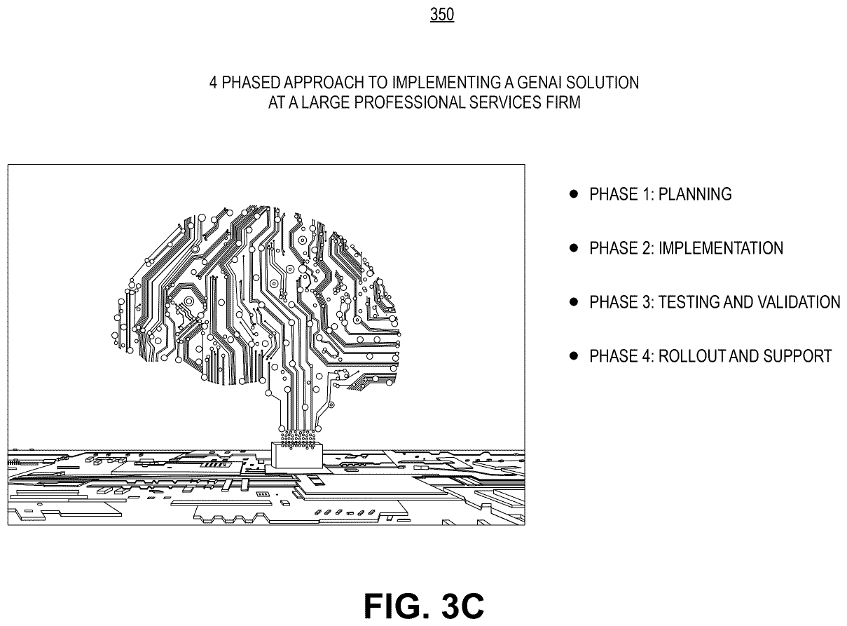

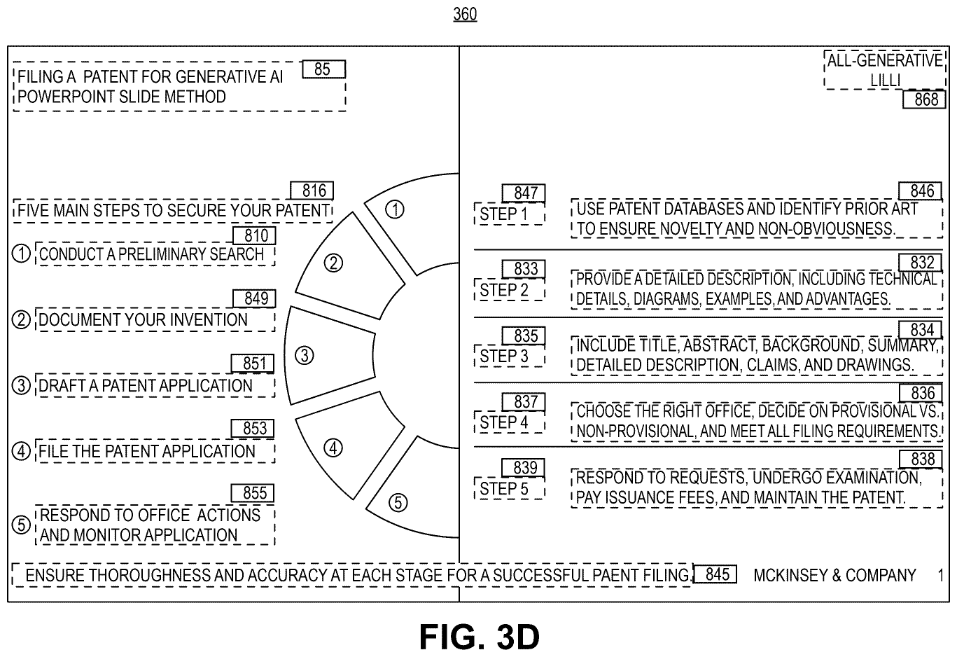

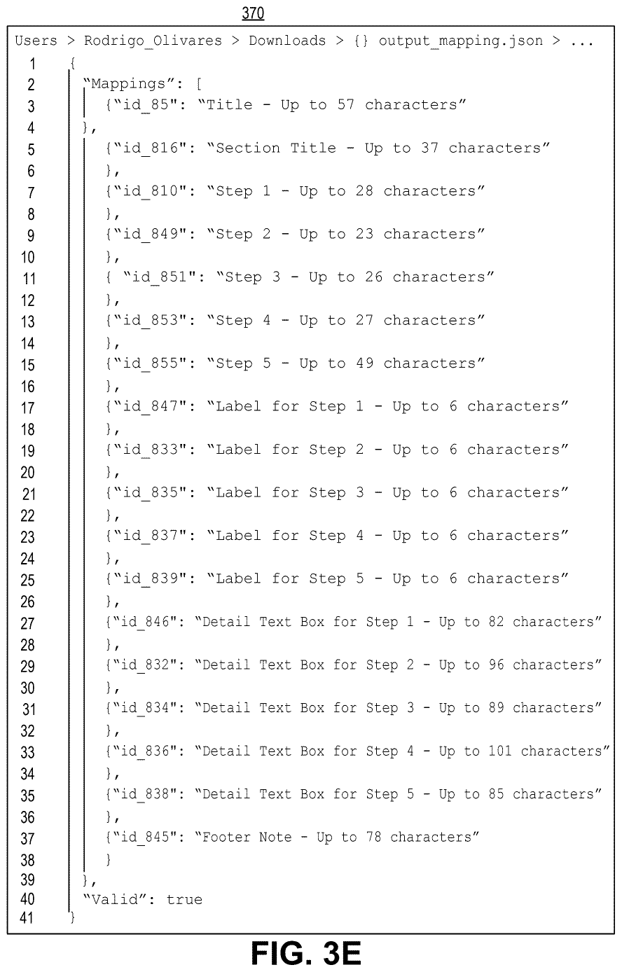

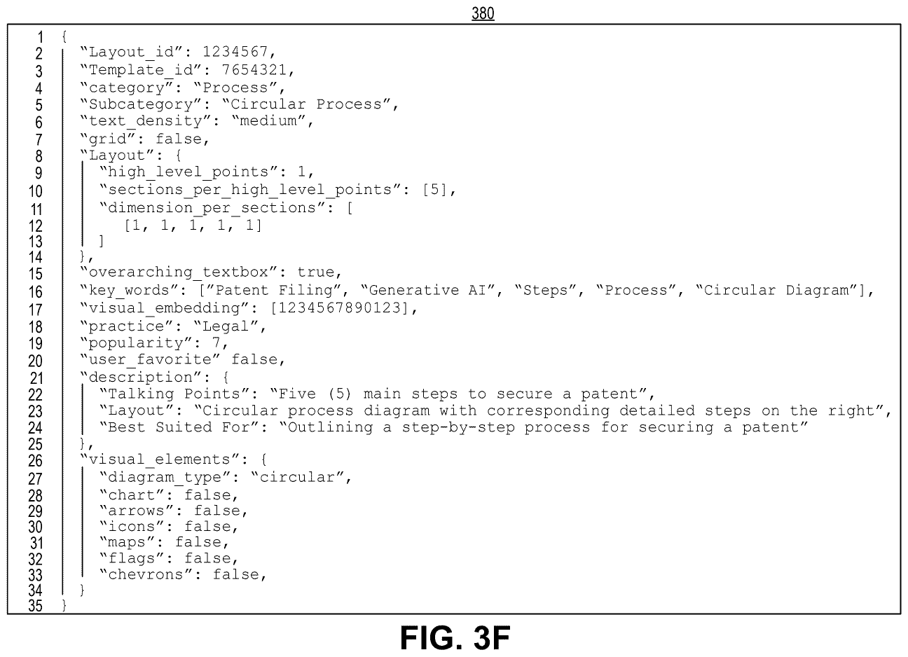

FIG. 3A depicts an exemplary slide 300 generated using machine learning according to the present techniques, according to some embodiments. FIG. 3C depicts an exemplary slide 350 generated using conventional techniques, according to some embodiments.

The server 105 or other suitable computing device 115 may generate the new slide, for example when executing the Slide Generator application 128. To generate the new slide, the Slide Generator application 128 via the server 105 server may obtain the content for the new slide, for example obtaining content from storage (e.g., the memory 124, database 126), from a user of the Slide Generator application 128 (e.g., via a user interface of the server or otherwise computing device communicatively coupled to the server), from the output of an ML model (e.g., the ML models 130) trained to generate slide content data, and/or any other suitable source of new slide content. It should be understood that one or more steps of generating the new slide 300 may be automated, semi-automated, and or manually-initiated by the user. In one example, a user may provide, via the Slide Generator application 128, a prompt to generate slide content on a particular topic to the LLM (e.g., the LLM 132, 286) at least trained to generate slide content, with the remaining steps of generating the new side 300 being are automated via the Slide Generator application 128 without further user interaction.

The content of the new slide 300 may be associated with implementing generative AI, and the associated content (e.g., text) may include and/or indicate:

Four-Phased Change Management Approach For Implementing Generative AI Ensuring successful adoption and integration of GenAI within a large professional services.

### Phase 1: Awareness & Alignment

(1) Develop a multi-channel communication strategy to inform employees about GenAI integration.
(2) Align and involve top management to champion the GenAI initiative and mobilize informal leaders.

### Phase 2: Engagement & Skill Building

(3) Identify key stakeholders, involve them early, and conduct workshops to foster trust and reduce resistance.
(4) Address cultural aspects that may facilitate or hinder the acceptance of GenAI.

### Phase 3: Use Case Development

(5) Provide comprehensive training programs and resources to enable employees to adapt to GenAI.
(6) Launch engagement activities to involve employees at all stages of the change process and foster ownership.

### Phase 4: Reinforcement & Improvement

(7) Define and prioritize GenAI use cases based on their potential impact and feasibility.
(8) Build a business case for each use case, outlining expected benefits, costs, and risks.

### Key Takeaway

Embed GenAI in business processes, use KPIs to measure impact, and establish a GenAI Center of Excellence.

To generate a description of an ideal slide layout for the new slide content, the Slide Generator application 128 may generate a first prompt for the LLM. For example, the first prompt may request: “Generate the ideal slide layout for [content],” where “[content]” represents the aforementioned text of the new slide content. In response to the LLM receiving the first prompt from the Slide Generator application 128, the LLM may generate new slide layout data including the description of the ideal layout to display the content of the new slide. In at least some embodiments, the new slide layout data may indicate one or more slide layout categories, such as layouts for one or more of charts, graphs, tables, text, images, etc. In one example, new slide layout data for the of the new slide content may indicate a layout for a process, a layout for a four-phase process, a layout for an eight-step process, and the like. In another example, the new slide layout data may indicate the slide layout should include a title text box (e.g., for the slide title), a sub-title text box (e.g., for the slide sub-title), four process title text boxes (e.g., for the titles of the four phases), eight description text boxes (e.g., for the descriptions of the process steps for the phases), a footer title text box (e.g., for the key takeaway) and a footer description text box (e.g., for the key takeaway description). The new slide layout description may include any other suitable description of the ideal layout of the new slide to display the content.

The Slide Generator application 128 may cause the server 105 to obtain template slide layout data for multiple template slides likewise describing the layout of each of the template slides. Using the new slide layout data and the template slide layout data, the Slide Generator application 128 may compare the description of the ideal layout for the new slide content with the descriptions of the layouts of the template slides to determine one or more template slides having layouts similar to the ideal layout of the new slide 300. In one example where the slide layouts are categorized, the Slide Generator application 128 may determine one or more template slides using one or more categories of the new slide layout and one or more categories of the template slides to find template slides having similar categories as the new slide layout. In another example the new slide layout description of the new slide 300 may be embedded (e.g., into a vector) and searched against layout descriptions of the template slides that are also embedded to find similarities (e.g., via a cosine similarity vector search) between the new slide layout description and template layout descriptions.

In at least some embodiments, the Slide Generator application 128 may find one template slide best suited to display the new slide content, and the layout of the template slide will be used to generate the new slide 300. In at least some embodiments, the Slide Generator application 128 may determine a subset of template slides from the available template slides having layouts that may be ideal and/or otherwise suitable for the content of the new slide and/or are similar to the ideal layout of the new slide. In embodiments where the Slide Generator application 128 determines a subset of template slides for the new slide content, the Slide Generator application 128 may generate a second prompt for selecting one template slide of the subset of template slides that may be best suited for the new slide content, and the layout of the selected slide may be used as the layout for the new slide 300. For example, the prompt may include a request: “You are an expert PPT designer. From the template slide layouts already selected, choose one template slide layout that would most effectively display this [content].” In response to the LLM receiving the second prompt, the LLM may cause the Slide Generator application 128 to execute (e.g., via the ML module 142, the ML engine 210 of the server 105) the template recommendation model (e.g., the template recommendation model 134, 222). The Slide Generator application 128 may provide the content data for the new slide 300 and template layout data for the subset of template slides as an input to the template recommendation model which selects one template slide and/or template slide layout as an output. In at least some embodiments, the Slide Generator application 128 may request the user select a template slide layout, for example by generating a user interface including images of the template slides that allows the user to select one as the layout for the new slide 300.

FIG. 3B depicts an exemplary template slide 310 having an ideal layout for the new slide content, according to some embodiments. The layout data for the template slide 310 may describe the template slide layout as a having a layout for an eight-step process. Based upon the description, the Slide Generator application 128 may select and/or recommend the 310 as the best-suited template slide layout for the new content data.

The Slide Generator application 128 may generate (e.g., from the template slide file/data) or otherwise obtain (e.g., from the memory 124, the database 126) template slide metadata indicating the layout characteristics of one or more elements of the template slide 310, such as the number of text boxes, their size, font type, coordinates, etc. For example, the metadata for the template slide 310 may indicate (i) one text box 312 having 54 point Aptos bold font; (ii) one text box 312A having 22 point Aptos font; (iii) four text boxes 314A-314D having 18 point Aptos font; (iv) eight text boxes 316A-316H having 14 point Aptos font; (v) one text box 318 having 16 point Aptos bold font; and (vi) one text 318A box having 14 point Aptos font. The metadata for the template slide 310 may also include the coordinates, size and/or otherwise dimensions of each text box. The Slide Generator application 128 may generate and/or otherwise obtain (e.g., from the memory 124, the database 126, the computing device 115) an image of the template slide, for example based upon the template slide file. The Slide Generator application 128 may provide the template slide metadata and the template slide image data to the layout-mapping model (e.g., the layout-mapping model 136, 224) as an input to generate template slide element mapping data as an output that includes a description of the one or more elements of the template slide 310.

The description of an element of the template slide may include an identifier, a type of content of the text box, a shape of the text box, or a text capacity of the text box. Returning to FIG. 3B, the mapping of the elements of the template slide 310 may indicate for (i) text box 312 the identifier is “312”, the shape is rectangle, the content is a title, and the text capacity is 100 characters; (ii) for text box 312A the identifier is “312A”, the shape is rectangle, the content is a sub-title, and the text capacity is 50 characters; (iii) each text box 314A, 314B, 314C and 314D the identifiers are “314A”, “314B”, “314C” and “314D” respectively, the shape is a chevron, the content is a step, and the text capacity is 20 characters; (iv) each text box 316A, 316B, 316C, 316D, 316E, 316F, 316G and 316H the identifiers are “316A”, “316B”, “316C”, “316D”, “316E”, “316F”, “316G” and “316H” respectively, the shape is a rectangle, the content is a description, and the text capacity is 200 characters; (v) text box 318 the identifier is “318”, the shape is rectangle, the content is a footer, and the text capacity is 30 characters; and (vi) text box 318A the identifier is “318A”, the shape is rectangle, the content is a sub-footer, and the text capacity is 50 characters. The element descriptions may indicate the logical and/or hierarchical relationships between elements. For example, in addition to indicating an element is a description textbox, it should may also indicate it is the description for Step 1 of a process.

The Slide Generator application 128 may generate a third prompt for the LLM to generate the new slide 300 based on the new slide content and the description of the one or more elements of the template slide (e.g., as indicated by the template slide element mapping data). In response to the LLM receiving the third prompt, the LLM may cause the slide generator model (e.g., the slide generator model 138, 226) to generate the new slide 300. The slide generator model may receive (e.g., form the LLM, the 128, the server 105, etc.) the template slide element mapping data and the content data as an input. The slide generator model may generate the new slide 300 by generating a mapping of the content to the one or more elements of the template slide.

Returning to FIG. 3B, mapping the new slide content to the template elements may include mapping: (i) the content title to the title box 312; (ii) the content sub-title to the sub-title text box 312A; (iii) the content four phase titles to the four chevrons 314A-314D; (iv) the content eights phase step descriptions to the eight description text boxes 316A-316H; (v) the Key Takeaway to the footer description text 318; and the Key Takeaway description to the sub-footer description text 318A.

The slide generator model may populate the template slide elements indicated in the template slide element mapping data with the associated new slide content of the new slide content data. With simultaneous reference to FIGS. 3A and 3B, the new slide 300 includes (i) the content title 302 populated into the title box 312; (ii) the content sub-title 302A populated into the sub-title text box 312A; (iii) the content four phase titles 304A-304D populated into the four chevrons 314A-314D; (iv) the content eights phase step descriptions 306A-306H populated into the eight description text boxes 316A-316H; (v) the Key Takeaway text 308 populated into the footer description text 318; and the Key Takeaway description 308A populated into the sub-footer description text 318A. The Slide Generator application 128 may display, at a user interface (e.g., display 154) of a computing device (the server 105, the computing device 115), the new slide 300.

Advantageously, the Slide Generator application 128 may generate slides based upon an existing library of template using the disclosed techniques, unlike conventional slide generation tools which may rely on a limited number of custom templates created for the slide generation tool, for example custom templates having placeholders tagged with metadata to direct the conventional slide generation tool when generating the new slide. FIG. 3C depicts an exemplary slide 350 of a conventional slide generation tool, according to some embodiments. The slide 350 includes basic elements such as one title and four bullet-point text boxes to display the new slide content. Comparatively, the new slide 300 includes a greater variety and larger quantity of elements to display the new slide context to provide a slide that is more sophisticated in complexity, and provides the new slide content in greater detail. Moreover, the new slide 300 is not built from scratch, but rather from an existing template providing the benefit that a library of existing templates generated over time that may each have a specific “look and feel” may be exploited to generate an infinite number of new slides.

FIG. 3D depicts an exemplary template slide 360 having elements identifiers and bounding boxes, according to some embodiments.

FIG. 3E depicts an exemplary template slide element mapping 370 for the template slide 360, according to some embodiments.

FIG. 3F depicts an exemplary template slide layout 380 for the template slide 360, according to some embodiments.

### Exemplary Computer-Implemented Method for Generating a Slide Using Machine Learning

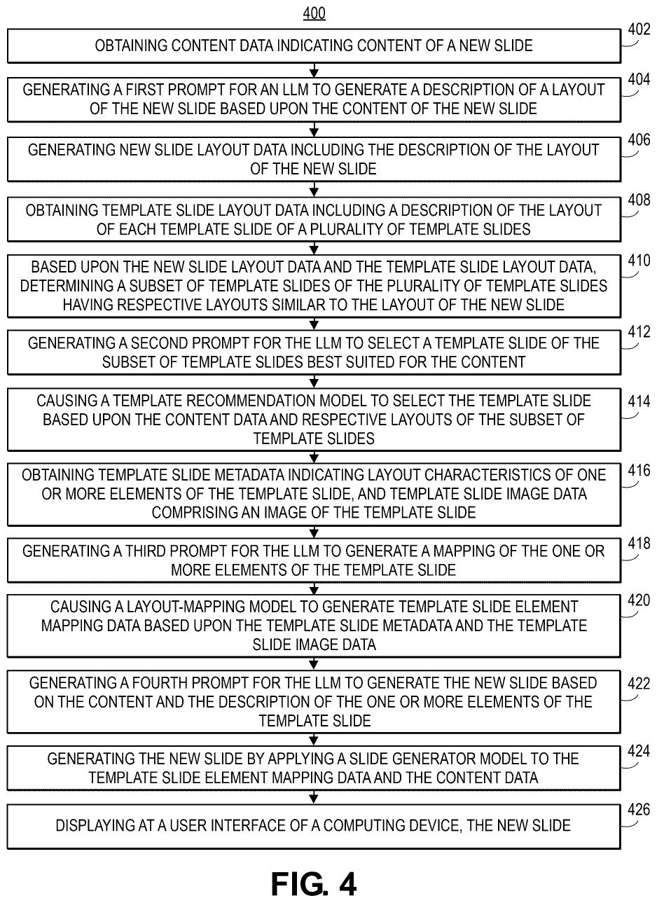

FIG. 4 is a flow diagram depicting an exemplary computer-implemented method 400 for generating a slide using machine learning, according to some embodiments. In general, the computer-implemented method 400 may be performed by the devices (e.g., the server 105, the computing device 115), models (the ML models 130, 220), and/or other components of the computing environment 100. One or more steps of the computer-implemented method 400 may be implemented as a set of instructions stored on a non-transitory computer-readable memory (e.g., the memory 124) and executable by one or more processors (e.g., the processor 120).

The computer-implemented method 400 may include obtaining (e.g., from the memory 124, the database 126, a computing device 115) content data indicating content (e.g., text) of a new slide (block 402).

The computer-implemented method 400 may include generating a first prompt for a large language model (LLM) (e.g., the LLM 132) to generate a description of a layout of the new slide based upon the content of the new slide (block 404).

The computer-implemented method 400 may include, responsive to the LLM receiving the first prompt, generating new slide layout data including the description of the layout of the new slide (block 406).

The computer-implemented method 400 may include obtaining (e.g., from the memory 124, the database 126, the computing device 115) template slide layout data including a description of the layout of each template slide of a plurality of template slides (block 408).

The computer-implemented method 400 may include, based upon the new slide layout data and the template slide layout data, determining a subset of template slides of the plurality of template slides having respective layouts similar to the layout of the new slide (block 410). In at least some embodiments, the computer-implemented method 400 may include determining one or more categories of the plurality of template slides, wherein determining the subset of template slides is further based upon the one or more categories of the template slide.

The computer-implemented method 400 may include generating a second prompt for the LLM to select and/or recommend a template slide of the subset of template slides best suited for the content (block 412), wherein the template slide is used as a template for the new slide.

The computer-implemented method 400 may include, responsive to the LLM receiving the second prompt, causing a template recommendation model (e.g., the template recommendation model 134, 222) to select and/or recommend the template slide based upon the content data and respective layouts of the subset of template slides (block 414). The template recommendation model may be trained using template recommendation model training data (e.g., the training data 230). The template recommendation model training data may include historical slides including historical content and historical layouts of historical template slides. The template recommendation model may be trained to make associations between the historical template slides having the historical layouts best suited for displaying the historical content. In at least some embodiments, the template recommendation model may determine the subset of template slides based upon the new slide layout data and the template slide layout data.

In at least some embodiments, the computer-implemented method 400 may include displaying, at the user interface, an indication of the subset of template slides, and receiving, via the user interface, a selection of the template slide.

The computer-implemented method 400 may include obtaining (e.g., from the memory 124, the database 126, the computing device 115) template slide metadata indicating layout characteristics of one or more elements of the template slide, and template slide image data comprising an image of the template slide (block 416). The layout characteristics may include a quantity of elements, a size of the element, a font of the element, a location of the element, and/or other suitable layout characteristic of the element.

The computer-implemented method 400 may include generating a third prompt for the LLM to generate a mapping of the one or more elements of the template slide (block 418) including a description of the one or more elements of the template slide. The description may include an identifier of the element, a type of content of the element, a shape of the element, and/or any other suitable description of the element.

The computer-implemented method 400 may include, responsive to the LLM receiving the third prompt, causing a layout-mapping model (e.g., the layout-mapping model 136, 224) to generate template slide element mapping data including the description of the one or more elements of the template slide based upon the template slide metadata and the template slide image data (block 420). The layout-mapping model may be trained using layout-mapping training data (e.g., the training data 230). The layout-mapping training data may include historical template slides including historical elements, historical template slide metadata of the historical template slides, historical template slide images of the historical slides, historical template slide mappings of the historical slides, and historical temple slide layouts of the historical slides. The layout-mapping model may be trained to make associations between historical images of the historical elements, the historical template slide layouts, historical layout characteristics of the historical elements, and historical descriptions of the historical elements. The layout-mapping model may include a GPT4Vision model, and/or other suitable model such as a multimodal LLM.

In at least some embodiments, the computer-implemented method 400 may include generating the template slide layout data for the plurality of template slides by applying the layout-mapping model to all template slide metadata indicating layout characteristics of the plurality of template slides, and all template slides image data comprising an image of each of the plurality of template slides.

The computer-implemented method 400 may include generating a fourth prompt for the LLM to generate the new slide based on the content and the description of the one or more elements of the template slide (block 422).

The computer-implemented method 400 may include, responsive to the LLM receiving the fourth prompt, generating the new slide by applying a slide generator model (e.g., the 138, 226) to the template slide element mapping data and the content data (block 424). Generating the new slide (block 426) may include generating a mapping of the content to the one or more elements of the template slide, and populating the one or more elements with the content based upon the mapping. The slide generator model may be trained using slide generator model training data (e.g., the training data 230). The slide generator model training data may include historical content of historical slides, historical template slides including historical elements, historical slide template mappings and historical slides having the historical content populated into the historical elements. The slide generator model may be trained to make associations between the historical elements, the historical content, and the historical content populated in the historical elements.

The computer-implemented method 400 may include displaying, at a user interface of a computing device (e.g., the computing device 115), the new slide (block 428).

In at least some embodiments of the computer-implemented method 400, the one or more elements include a text box. In such embodiments, the layout characteristics of the one or more elements may include one or more of: a quantity of text boxes, a size of the text box, a font of the text box, or a location of the text box, and/or the description of the one or more elements includes one or more of: an identifier, a type of content of the text box, a shape of the text box, or a text capacity of the text box.

In at least some embodiments of the computer-implemented method 400, the new slide is a first new slide of a plurality of new slides, and the computer-implemented method 400 may further include generating the plurality of new slides.

It should be understood that not all blocks of the exemplary flow diagram of FIG. 4 are required to be performed. Additionally, the computer-implemented method 400 may include fewer, additional, and/or other steps than those depicted in FIG. 4.

### Additional Considerations

With the foregoing, users whose data is being collected and/or utilized may first opt-in. After a user provides affirmative consent, data may be collected from the user's device (e.g., a mobile computing device). In other embodiments, deployment and use of ML models at a client or user device may have the benefit of removing any concerns of privacy or anonymity, by removing the need to send any personal or private data to a remote server.

The following additional considerations apply to the foregoing discussion. Throughout this specification, plural instances may implement operations or structures described as a single instance. Although individual operations of one or more methods are illustrated and described as separate operations, one or more of the individual operations may be performed concurrently, and nothing requires that the operations be performed in the order illustrated. These and other variations, modifications, additions, and improvements fall within the scope of the subject matter herein.

The patent claims at the end of this patent application are not intended to be construed under 35 U.S.C. § 112(f) unless traditional means-plus-function language is expressly recited, such as “means for” or “step for” language being explicitly recited in the claim(s). The systems and methods described herein are directed to an improvement to computer functionality, and improve the functioning of conventional computers.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment”, “in one aspect” and/or the like in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (e.g., code embodied on a machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory product to which it is communicatively coupled. A further hardware module may then, at a later time, access the memory product to retrieve and process the stored output. Hardware modules may also initiate communications with input or output products, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a building environment, an office environment or as a server farm), while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a building environment, an office environment, or a server farm). In other example embodiments, the one or more processors or processor-implemented modules may be distributed across a number of geographic locations.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

Upon reading this disclosure, those of skill in the art will appreciate still additional alternative structural and functional designs for the method and systems described herein through the principles disclosed herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

Thus, many modifications and variations may be made in the techniques, methods, and structures described and illustrated herein without departing from the spirit and scope of the present claims. Accordingly, it should be understood that the methods and apparatus described herein are illustrative only and are not limiting upon the scope of the claims.

What is claimed:

1. A system for generating a slide using machine learning, the system comprising:
one or more processors; and
one or more non-transitory memories storing processor-executable instructions that, when executed by the one or more processors, cause the system to:
obtain content data indicating content of a new slide;
generate a first prompt for a large language model (LLM) to generate a description of a layout of the new slide based upon the content of the new slide;
responsive to the LLM receiving the first prompt, generate new slide layout data including the description of the layout of the new slide;
obtain template slide layout data including a description of the layout of each template slide of a plurality of template slides;
based upon the new slide layout data and the template slide layout data, determine a subset of template slides of the plurality of template slides having respective layouts similar to the layout of the new slide;
generate a second prompt for the LLM to select a template slide of the subset of template slides best suited for the content, wherein the template slide is used as a template for the new slide;
responsive to the LLM receiving the second prompt, cause a template recommendation model to select the template slide based upon the content data and respective layouts of the subset of template slides;
obtain template slide metadata indicating layout characteristics of one or more elements of the template slide, and template slide image data comprising an image of the template slide;
generate a third prompt for the LLM to generate a mapping of the one or more elements of the template slide including a description of the one or more elements of the template slide;
responsive to the LLM receiving the third prompt, cause a layout-mapping model to generate template slide element mapping data including the description of the one or more elements of the template slide based upon the template slide metadata and the template slide image data;
generate a fourth prompt for the LLM to generate the new slide based on the content and the description of the one or more elements of the template slide;
responsive to the LLM receiving the fourth prompt, generate the new slide by applying a slide generator model to the template slide element mapping data and the content data, wherein to generate the new slide includes:
generating a mapping of the content to the one or more elements of the template slide, and
populating the one or more elements with the content based upon the mapping; and
display, at a user interface of a computing device, the new slide.

2. The system of claim 1, wherein:
the one or more elements include a text box; and
one or more of:
the layout characteristics of the one or more elements include one or more of: a quantity of text boxes, a size of the text box, a font of the text box, or a location of the text box, or
the description of the one or more elements includes one or more of: an identifier, a type of content of the text box, a shape of the text box, or a text capacity of the text box.

3. The system of claim 1, wherein:
the new slide is a first new slide of a plurality of new slides; and
the system further comprising instructions that, when executed by the one or more processors, cause the system to generate the plurality of new slides.

4. The system of claim 1, further comprising instructions that, when executed by the one or more processors, cause the system to:
display, at the user interface, an indication of the subset of template slides; and
receive, via the user interface, a selection of the template slide.

5. The system of claim 1, further comprising instructions that, when executed by the one or more processors, cause the system to:
determine one or more categories of the plurality of template slides, wherein to determine the subset of template slides is further based upon the one or more categories of the template slide.

6. The system of claim 1, further comprising instructions that, when executed by the one or more processors, cause the system to:
generate the template slide layout data for the plurality of template slides by applying the layout-mapping model to all template slide metadata indicating layout characteristics of the plurality of template slides, and all template slides image data comprising an image of each of the plurality of template slides.

7. The system of claim 1, wherein:
the template recommendation model is trained using template recommendation model training data including historical slides including historical content and historical layouts of historical template slides; and
the template recommendation model is trained to make associations between the historical template slides having the historical layouts best suited for displaying the historical content.

8. The system of claim 1, wherein the template recommendation model determines the subset of template slides based upon the new slide layout data and the template slide layout data.

9. The system of claim 1, wherein:
the layout-mapping model is trained using layout-mapping model training data including historical template slides including historical elements, historical template slide metadata of the historical template slides, historical template slide images of the historical slides, historical template slide mappings of the historical slides, and historical temple slide layouts of the historical slides; and
the layout-mapping model is trained to make associations between historical images of the historical elements, the historical template slide layouts, historical layout characteristics of the historical elements, and historical descriptions of the historical elements.

10. The system of claim 1, wherein the layout-mapping model includes a GPT4Vision model.

11. The system of claim 1, wherein:
the slide generator model is trained using slide generator model training data including historical content of historical slides, historical template slides including historical elements, historical slide template mappings and historical slides having the historical content populated into the historical elements; and
the slide generator model is trained to make associations between the historical elements, the historical content, and the historical content populated in the historical elements.

12. A computer-implemented method for generating a slide using machine learning, the computer-implemented method comprising:
obtaining, by one or more processors, content data indicating content of a new slide;
generating, by the one or more processors, a first prompt for a large language model (LLM) to generate a description of a layout of the new slide based upon the content of the new slide;
responsive to the LLM receiving the first prompt, generating, by the one or more processors, new slide layout data including the description of the layout of the new slide;
obtaining, by the one or more processors, template slide layout data including a description of the layout of each template slide of a plurality of template slides;
based upon the new slide layout data and the template slide layout data, determining, by the one or more processors, a subset of template slides of the plurality of template slides having respective layouts similar to the layout of the new slide;
generating, by the one or more processors, a second prompt for the LLM to select a template slide of the subset of template slides best suited for the content, wherein the template slide is used as a template for the new slide;
responsive to the LLM receiving the second prompt, causing, by the one or more processors, a template recommendation model to select the template slide based upon the content data and respective layouts of the subset of template slides;
obtaining, by the one or more processors, template slide metadata indicating layout characteristics of one or more elements of the template slide, and template slide image data comprising an image of the template slide;
generating, by the one or more processors, a third prompt for the LLM to generate a mapping of the one or more elements of the template slide including a description of the one or more elements of the template slide;
responsive to the LLM receiving the third prompt, causing, by the one or more processors, a layout-mapping model to generate template slide element mapping data including the description of the one or more elements of the template slide based upon the template slide metadata and the template slide image data;
generating, by the one or more processors, a fourth prompt for the LLM to generate the new slide based on the content and the description of the one or more elements of the template slide;
responsive to the LLM receiving the fourth prompt, generating, by the one or more processors, the new slide by applying a slide generator model to the template slide element mapping data and the content data, wherein to generating the new slide includes:
generating a mapping of the content to the one or more elements of the template slide, and
populating the one or more elements with the content based upon the mapping; and
displaying, by the one or more processors at a user interface of a computing device, the new slide.

13. The computer-implemented method of claim 12, wherein:
the one or more elements include a text box; and
one or more of:
the layout characteristics of the one or more elements include one or more of: a quantity of text boxes, a size of the text box, a font of the text box, or a location of the text box, or
the description of the one or more elements includes one or more of: an identifier, a type of content of the text box, a shape of the text box, or a text capacity of the text box.

14. The computer-implemented method of claim 12, wherein:
the new slide is a first new slide of a plurality of new slides; and
the computer-implemented method further comprises generating, by the one or more processors, the plurality of new slides.

15. The computer-implemented method of claim 12, further comprising:
displaying, by the one or more processors at the user interface, an indication of the subset of template slides; and
receiving, by the one or more processors via the user interface, a selection of the template slide.

16. The computer-implemented method of claim 12, further comprising:
generating, by the one or more processors, the template slide layout data for the plurality of template slides by applying the layout-mapping model to all template slide metadata indicating layout characteristics of the plurality of template slides, and all template slides image data comprising an image of each of the plurality of template slides.

17. The computer-implemented method of claim 12, wherein:
the template recommendation model is trained using template recommendation model training data including historical slides including historical content and historical layouts of historical template slides; and
the template recommendation model is trained to make associations between the historical template slides having the historical layouts best suited for displaying the historical content.

18. The computer-implemented method of claim 12, wherein:
the layout-mapping model is trained using layout-mapping model training data including historical template slides including historical elements, historical template slide metadata of the historical template slides, historical template slide images of the historical slides, historical template slide mappings of the historical slides, and historical temple slide layouts of the historical slides; and
the layout-mapping model is trained to make associations between historical images of the historical elements, the historical template slide layouts, historical layout characteristics of the historical elements, and historical descriptions of the historical elements.

19. The computer-implemented method of claim 12, wherein:
the slide generator model is trained using slide generator model training data including historical content of historical slides, historical template slides including historical elements, historical slide template mappings and historical slides having the historical content populated into the historical elements; and
the slide generator model is trained to make associations between the historical elements, the historical content, and the historical content populated in the historical elements.

20. A non-transitory computer readable medium having processor-executable instructions stored thereon that, when executed by one or more processors, cause the one or more processors to at least:
obtain content data indicating content of a new slide;
generate a first prompt for a large language model (LLM) to generate a description of a layout of the new slide based upon the content of the new slide;
responsive to the LLM receiving the first prompt, generate new slide layout data including the description of the layout of the new slide;
obtain template slide layout data including a description of the layout of each template slide of a plurality of template slides;
based upon the new slide layout data and the template slide layout data, determine a subset of template slides of the plurality of template slides having respective layouts similar to the layout of the new slide;
generate a second prompt for the LLM to select a template slide of the subset of template slides best suited for the content, wherein the template slide is used as a template for the new slide;
responsive to the LLM receiving the second prompt, cause a template recommendation model to select the template slide based upon the content data and respective layouts of the subset of template slides;
obtain template slide metadata indicating layout characteristics of one or more elements of the template slide, and template slide image data comprising an image of the template slide;
generate a third prompt for the LLM to generate a mapping of the one or more elements of the template slide including a description of the one or more elements of the template slide;
responsive to the LLM receiving the third prompt, cause a layout-mapping model to generate template slide element mapping data including the description of the one or more elements of the template slide based upon the template slide metadata and the template slide image data;
generate a fourth prompt for the LLM to generate the new slide based on the content and the description of the one or more elements of the template slide;
responsive to the LLM receiving the fourth prompt, generate the new slide by applying a slide generator model to the template slide element mapping data and the content data, wherein to generate the new slide includes:
generating a mapping of the content to the one or more elements of the template slide, and
populating the one or more elements with the content based upon the mapping; and
display, at a user interface of a computing device, the new slide.
